(19) United States
(12) Patent Application Publication
(10) Pub. No.: US 2018/0091613 A1
(43) Pub. Date: Mar. 29, 2018

(54) ELECTRONIC DEVICE AND METHOD THEREOF FOR MANAGING NOTIFICATIONS

(71) Applicant: Samsung Electronics Co., Ltd., Suwon-si (KR)

(72) Inventors: Lowlish GOEL, Hanumangarh (IN); Lokendra KUMAR, BharatPur (IN)

(21) Appl. No.: 15/715,700

(22) Filed: Sep. 26, 2017

(30) Foreign Application Priority Data
Sep. 29, 2016 (IN) 201641033365

(51) Int. Cl. H04L 29/08; H04L 12/58; H04M 1/725; G06F 3/0481; G06F 3/0488; H04W 4/02

(52) U.S. Cl. CPC H04L 67/26; H04L 51/24; H04M 1/72547; H04W 88/02; G06F 3/04883; H04W 4/02; G06F 3/04817

(57) ABSTRACT

A method for managing notifications in an electronic device is provided. The method includes receiving, by a notification manager, at least one notification from a plurality of senders. The method includes causing, by the notification manager, to display a graphical representation comprising an identity of the at least one notification from each of the sender and at least one indicator indicating an identity of at least one application corresponding to the at least one notification.

### CROSS-REFERENCE TO RELATED APPLICATION(S)

This application claims the benefit under 35 U.S.C. §119(a) of an Indian patent application filed on Sep. 29, 2016 in the Indian Intellectual Property Office and assigned Serial number 201641033365, the entire disclosure of which is hereby incorporated by reference.

### TECHNICAL FIELD

The present disclosure relates to electronic devices. More particularly, the present disclosure relates to an electronic device and method thereof for managing notifications in an electronic device.

### BACKGROUND

Methods are used to display number of notifications over an application icon called a notification badge according to the related art. The notification badge represents number of unread notifications received by an electronic device of a user in a specific application. Over a time, as the user receives more and more notifications, counter in the notification badge increments continuously. Further, the notification badge provides information indicating new notifications received, by the user, in the application. Also, the user can miss important notifications due to increase in number of notifications been received by the electronic device or due to continuous increment in the counter of the notification badge.

In methods and systems, recent communication entry is displayed with existing call log according to the related art. Here, a call log manager tracks previous communication history and determines how to display a new communications log. Consider a scenario vhere the user receives a new message from a contact stored in the electronic device of the user. After receiving the message, the electronic device determines the previous communication history related to the contact. After determining the previous communication history, the recent communication details are added to the call log. Further, if the previous communication history is unavailable, then a new entry is added to the call logs corresponding to that contact in the call logs.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspects of the present disclosure is to provide a method and electronic device thereof for managing notifications.

Another aspect of the present disclosure is to provide a method for receiving, by a notification manager, at least one notification from a plurality of senders.

Another aspect of the present disclosure is to provide a method for causing, by the notification manager, to display a graphical representation including an identity of the at least one notification from each of the sender and at least one indicator indicating an identity of at least one application corresponding to the at least one notification.

Another aspect of the present disclosure is to provide a method for receiving, by a notification manager, at least one notification from a plurality of applications.

Another aspect of the present disclosure is to provide a method for causing, by he notification manager, to display a graphical representation including an identity of each of the application of the at least one notification and at least one indicator indicating an identity of at least one sender of the at least one notification.

In accordance with an aspect of the present disclosure, a method for managing notifications in an electronic device is provided. The method includes receiving, by a notification manager, at least one notification from a plurality of senders. Further, the method includes causing, by the notification manager, to display a graphical representation including an identity of the at least one notification from each of the sender and at least one indicator indicating an identity of at least one application corresponding to the at least one notification.

In accordance with another aspect of the present disclosure, the identity of the at least one notification from each of the senders is dynamically updated based on activities of a user of the electronic device.

In accordance with another aspect of the present disclosure, the identity for each of the notification to be displayed is automatically defined based on a plurality of parameters including at least one of a sender of the notification, content of the notification, one or more user activities, a location of the user of the electronic device, a location of the sender, a category of the notification, a degree of closeness, or a communication history.

In accordance with another aspect of the present disclosure, the identity to be displayed is defined based on a face value, where the face value is defined based on at least one of a number of notifications, the sender of the notification, the content of the notification, one or more user activities, the location of the user of the electronic device, the location of the sender, the category of the notification, the degree of closeness, or the communication history.

In accordance with another aspect of the present disclosure, the identity of the at least one notification includes at least one of a thumbnail image of at least one sender of the at least one notification, a name of the at least one sender of the at least one notification, a descriptor of the content of the at least one notification, or a user defined identifier for the at least one notification.

In accordance with another aspect of the present disclosure, the identity of the at least one application includes at least one of an image icon of the at least one application corresponding to the at least one notification, a name of the at least one application corresponding to the at least one notification, or a user defined identifier for the at least one application corresponding to the at least one notification.

In accordance with another aspect of the present disclosure, the identity of the at least one notification from each of the senders is scrolled based on a gesture performed on the graphical representation.

In accordance with another aspect of the present disclosure, the method further includes detecting, by the notification manager, a gesture performed on a portion of the graphical representation displaying the identity of the at least one notification. Further, the method includes performing, by the notification manager, an action to transition the portion of the graphical representation to display the content of the at least one notification within the portion of the graphical representation.

In accordance with another aspect of the present disclosure, the method further includes detecting, by the notification manager, the gesture performed on the portion of the graphical representation displaying the identity of the at least one notification. Further, the method includes causing, by the notification manager, to display the content of the notification on a screen of the electronic device.

In accordance with another aspect of the present disclosure, the method includes detecting, by the notification manager, the gesture performed to move at least one portion of the graphical representation to a specific area of the electronic device. Further, the method includes performing, by the notification manager, an action based on the gesture.

In accordance with another aspect of the present disclosure, a method for managing notifications in an electronic device is provided. The method includes receiving, by a notification manager, at least one notification from a plurality of applications. Further, the method includes causing, by the notification manager, to display a graphical representation including an identity of each of the application of the at least one notification and at least one indicator indicating an identity of at least one sender of the at least one notification.

In accordance with another aspect of the present disclosure, the identity of the at least one sender of the at least one notification is dynamically updated based on activities of a user of the electronic device.

In accordance with another aspect of the present disclosure, the identity of the at least one sender of the at least one notification to be displayed is automatically defined based on a plurality of parameters including at least one of a sender of the notification, content of the notification, one or more user activities, a location of a user of the electronic device, a location of the sender, a category of the notification, a degree of closeness, or a communication history.

In accordance with another aspect of the present disclosure, a face value of the identity to be displayed is defined based on a notification ratio, where the notification ratio is defined based on at least one of a number of notifications, the sender of the notification, the content of the notification, the user activities, the location of the user, the category of the notification, the degree of closeness, or the communication history.

In accordance with another aspect of the present disclosure, the identity of each of the application includes at least one of an image icon of the at least one application corresponding to the at least one notification, a name of the at least one application corresponding to the at least one notification, and a user defined identifier for the at least one application corresponding to the at least one notification.

In accordance with another aspect of the present disclosure, the identity of the at least one sender includes at least one of a thumbnail image of the at least one sender of the at least one notification, a name of the at least one sender of the at least one notification, a descriptor of content of the at least one notification, or a user defined identifier for the at least one notification.

In accordance with another aspect of the present disclosure, the identity of the at least one sender of the at least one notification is scrolled based on a gesture performed on the graphical representation.

In accordance with another aspect of the present disclosure, the method further includes detecting, by the notification manager, a gesture performed on the portion of the graphical representation displaying the identity of the at least one sender of the at least one notification. Further, the method includes performing, by the notification manager, an action to transition the portion of the graphical representation to display the content of the at least one notification within the portion of the graphical representation.

In accordance with another aspect of the present disclosure, the method includes detecting, by the notification manager, the gesture performed on the portion of the graphical representation displaying the identity of the at least one sender of the at least one notification. Further, the method includes causing, by the notification manager, to display the content of the notification on a screen of the electronic device.

In accordance with another aspect of the present disclosure, the method includes detecting, by the notification manager, the gesture performed to move at least one portion of the graphical representation to a specific area of the electronic device. Further, the method includes performing, by the notification manager, an action based on the gesture.

In accordance with another aspect of the present disclosure, an electronic device for managing notifications is provided. The electronic device includes a memory, a processor, coupled to the memory, and configured to receive at least one notification from a plurality of senders. Further, the notification manager configured to cause to display a graphical representation including an identity of the at least one notification from each of the sender and at least one indicator indicating an identity of at least one application corresponding to the at least one notification.

In accordance with another aspect of the present disclosure, an electronic device for managing notifications is provided. The electronic device includes a memory, a processor, coupled to the memory, and a notification manager configured to receive at least one notification from a plurality of applications. Further, the notification manager configured to cause to display a graphical representation including an identity of each of the application of the at least one notification and at least one indicator indicating an identity of at least one sender of the at least one notification.

In accordance with another aspect of the present disclosure, a computer program product including a computer executable program code recorded on a non-transitory computer readable non-transitory storage medium is provided. The computer executable program code when executed causing the actions including receiving, by a notification manager, at least one notification from a plurality of senders. Further, the computer executable program code when executed causing the actions including causing, by the notification manager, to display a graphical representation including an identity of the at least one notification from each of the sender and at least one indicator indicating an identity of at least one application corresponding to the at least one notification.

In accordance with another aspect of the present disclosure, a computer program product including a computer executable program code recorded on a non-transitory computer readable non-transitory storage medium is provided. The computer executable program code when executed causing the actions including receiving, by a notification manager, at least one notification from a plurality of applications. Further, the computer executable program code when executed causing the actions including causing, by the notification manager, to display a graphical representation including an identity of each of the application of the at least one notification and at least one indicator indicating an identity of at least one sender of the at least one notification.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is an example scenario in which a graphical representation including an image of at least one sender is displayed on an electronic device for representing a notification with an application icon, according to an embodiment of the present disclosure;

FIG. 1B is another example scenario in which a graphical representation including an image of a sender is displayed on a smart watch (i.e., the electronic device) for representing at least one notification with an application icon, according to an embodiment of the present disclosure;

FIG. 2 illustrates a block diagram of an electronic device for managing notifications, according to an embodiment of the present disclosure;

FIG. 3 is an example block diagram of a notification manager, according to an embodiment of the present disclosure;

FIG. 4 is a flowchart illustrating a method for managing notifications in an electronic device, according to an embodiment of the present disclosure;

FIG. 5 is a flowchart illustrating a method for displaying an identity after detecting a gesture performed by a user to move a graphical representation, according to an embodiment of the present disclosure;

FIG. 6 is a flowchart illustrating a method for managing notifications in an electronic device, according to an embodiment of the present disclosure;

FIG. 7 is a flowchart illustrating a method for performing an action based on a gesture performed by a user to move at least one portion of a graphical representation, according to an embodiment of the present disclosure;

FIG. 8 is a flowchart illustrating an overall proposed method for managing notifications in an electronic device and updating an image of the sender based on user activities, according to an embodiment of the present disclosure;

FIG. 9A is an example illustration in which a graphical representation including an identity of two notifications from each sender and an indicator indicating an identity of an application corresponding to the two notifications is displayed on an electronic device, according to an embodiment of the present disclosure;

FIG. 9B is an example scenario in which a graphical representation including a thumbnail image of senders of two notifications and a number of notifications with a color code is displayed on an electronic device, according to an embodiment of the present disclosure;

FIG. 9C is an example scenario in which a notification ratio is changed when a user receives a new notification from a previous sender, according to an embodiment of the present disclosure;

FIG. 9D is an example scenario in which a graphical representation is changed to include an additional image of a new sender after receiving a new notification from a new sender, according to an embodiment of the present disclosure;

FIG. 9E is an example scenario in which a view of a graphical representation displayed on an electronic device is changed by a user, according to an embodiment of the present disclosure;

FIG. 9F is an example scenario in which content of a notification is displayed on a screen of an electronic device, according to an embodiment of the present disclosure;

FIG. 9G is an example scenario in which a home page of an application is launched and displayed on a screen of an electronic device, according to an embodiment of the present disclosure;

FIG. 10A is an example scenario in which content of a notification is displayed on a screen of an electronic device after detecting a gesture performed by a user on an image of a sender, according to an embodiment of the present disclosure;

FIG. 10B is an example scenario in which a home page of an application is displayed on a screen of an electronic device, according to an embodiment of the present disclosure;

FIG. 11A is an example scenario in which a home page of an application is displayed on a screen of an electronic device, according to an embodiment of the present disclosure;

FIG. 11B is an example scenario in which a graphical representation including a thumbnail image of only one sender with small size is displayed on a screen of an electronic device, according to an embodiment of the present disclosure;

FIG. 11C is an example scenario in which a size of a graphical representation is increased to display more number of senders, according to an embodiment of the present disclosure;

FIG. 11D is an example scenario in which a grid size of a graphical representation is changed by a user, according to an embodiment;

FIGS. 12A, 12B, 12C, 12D, 12E, 12F, and 12G are example scenarios in which an identity of notifications from each sender is dynamically updated based on user activities, according to an embodiment of the present disclosure;

FIG. 13 is an example scenario in which a graphical representation including an identity depicting a received notification content and an indicator indicating an identity of a sender of a notification, according to an embodiment of the present disclosure;

FIG. 14 is an example scenario in which a graphical representation including emoticons to display notification context; and an image icon and name of an application, according to an embodiment of the present disclosure;

FIG. 15 is an example scenario in which a graphical representation including images of senders displayed according to a number of messages received from different senders, according to an embodiment of the present disclosure;

FIG. 16 is an example scenario in which a graphical representation including a thumbnail image of applications of notifications and an image of a sender is displayed on a screen of an electronic device, according to an embodiment of the present disclosure;

FIGS, 17A, 17B, and 17C are example scenarios in which a user can directly access a notification in a particular application by performing a gesture, according to an embodiment of the present disclosure;

FIGS. 18A and 18B are example scenarios in which a user selects senders for which the user needs to view an image of the senders when a notification is received, according to an embodiment of the present disclosure;

FIGS. 19A, 19B, and 19C are example scenarios in which a user can access notifications received from different senders by performing a gesture on a graphical representation, according to an embodiment of the present disclosure;

FIGS. 20A, 20B, and 20C are example scenarios in which images of senders are displayed based on a location of a user, according to an embodiment of the present disclosure;

FIG. 21 is an example scenario in which images of sender are displayed when a user performs a gesture on a thumbnail image of an application, according to an embodiment of the present disclosure;

FIGS. 22A, 22B, and 22C are example scenarios in which information of a sender is displayed when a graphical representation is moved to an edge area (i.e., specific area) of an electronic device, according to an embodiment of the present disclosure;

FIG. 23 is an example scenario in which content of a notification is displayed on a screen of an electronic device, according to an embodiment of the present disclosure;

FIG. 24A is an example scenario in which a graphical representation including images of senders of a notification and a thumbnail image and a name of an application is displayed on a screen of a smart watch, according to an embodiment of the present disclosure;

FIG. 24B is an example scenario in which a bezel of a smart watch is rotated to view notifications received from other senders, according to an embodiment of the present disclosure;

FIG. 24C is an example scenario in which a gesture is performed on an image of a sender to display entire content of a notification on a screen of an electronic device, according to an embodiment of the present disclosure;

FIG. 25 is an example scenario in which an image of a sender is flipped where a user can respond to a notification, according to an embodiment of the present disclosure;

FIG. 26 is an example scenario in which an image of two or more senders is displayed in an adjacent pop-up window, according to an embodiment of the present disclosure;

FIG. 27 is an example scenario in which images of senders are updated based on user activities, according to an embodiment of the present disclosure;

FIG. 28 is an example scenario in which images of senders are updated based on current location of a user, according to an embodiment of the present disclosure;

FIG. 29 is another example scenario in which an image of an application is updated based on activities of a user, according to an embodiment of the present disclosure;

FIG. 30 is an example scenario in which an image of a sender within a graphical representation is changed with a movie poster and liked status, according to an embodiment of the present disclosure;

FIG. 31 is an example scenario in which a party schedule is displayed to a user of an electronic device, according to the embodiment of the present disclosure; and

FIG. 32 illustrates a computing environment implementing the method for managing notifications in an electronic device, according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details such to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block, may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiments herein provide a method for managing notifications in an electronic device. The method includes receiving at least one notification from a plurality of senders. Further, the method includes causing to display a graphical representation including an identity of the at least one notification from each of the sender and at least one indicator indicating an identity of at least one application corresponding to the at least one notification.

Another embodiment herein provides a method for managing notifications in the electronic device. The method includes receiving the at least one notification from the plurality of applications. Further, the method includes causing to display the graphical representation including the identity of each of the application of the at least one notification and the at least one indicator indicating the identity of the at least one sender of the at least one notification.

Unlike systems and methods, the proposed method provides a simple and robust method for managing notifications available in the electronic device according to the related art. The proposed method relates to updating of a user interface (UI) based on new notifications received by the user. Further, the users are provided with more information and the information is updated based on user activity such that the user can correlate current activity with the notifications received,

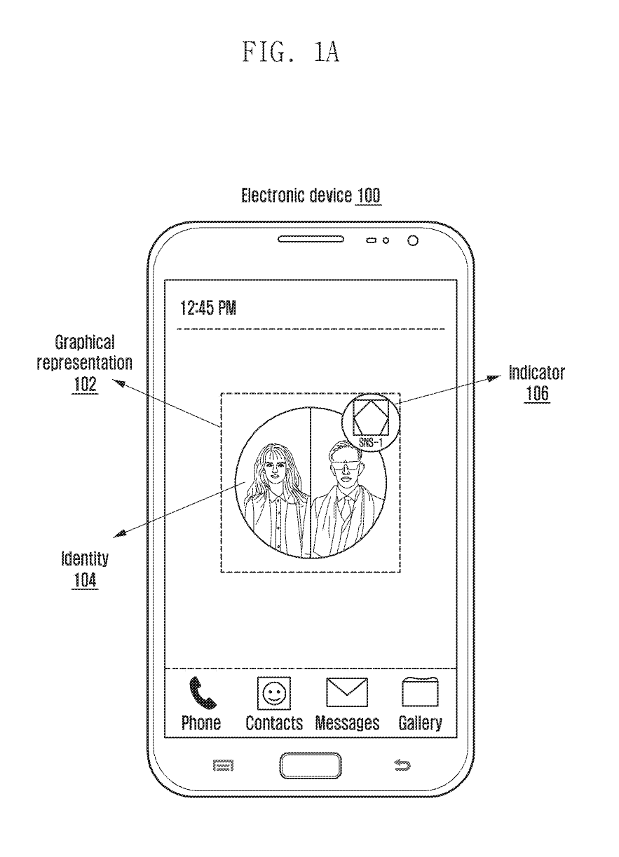

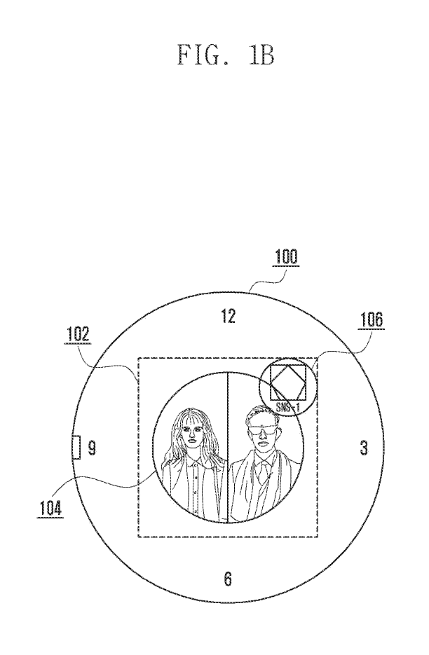

Referring now to the drawings, and more particularly to FIGS. 1A through 32, where similar reference characters denote corresponding features consistently throughout the figures, there are shown preferred embodiments.

FIG. 1A is an example scenario in which a graphical representation 102 including an image of at least one sender is displayed on an electronic device 100 for representing a notification with an application icon, according to an embodiment of the present disclosure. Consider a scenario where a user of the electronic device 100 receives notifications from a plurality of senders. For example, the electronic device 100 tracks the number of notifications received from the plurality of senders within an application. In accordance with an aspect of the present disclosure, for example, the application is at least one of a message application, an e-mail application, an instant message application, a phone application (or a call application), or a social network service application (SNS) application. In accordance with an aspect of the present disclosure, the application is an application related to messages or communications.

After tracking the number of notifications, the electronic device 100 calculates notification ratio for each of the sender with respect to the plurality of senders within the application. Based on the calculated notification ratio, images of the senders are fetched from contacts and a graphical representation 102 (i.e., a pie-chart) is generated. The graphical representation 102 including the images of the senders (i,e., identity 104) and the notification of the application (i.e., indicator 106) (i.e., application icon) is displayed on a screen of the electronic device 100. The indicator 106 includes at least one a name of the application and a representation image of the application. As shown in FIG. 1A, for convenience, although the graphical representation 102 including the images of the two senders as shown in FIG. 1A. It is to be understood that the graphical representation 102 can include the images of more than two senders without departing from the scope of the invention.

Further, the size of the image of the sender depends on the notification ratio. The user can directly access the notification by performing a gesture on the image of the particular sender or the application icon to access a home page of that application. In an embodiment, the gesture can be a touch gesture, a hover gesture, a swipe gesture, a drag and drop gesture, or the like. As shown in FIG. 1A, the user can perform the gesture on the application icon to access the home page of the application. Unlike related-art methods, the proposed method can be used to display the notifications using the images of the senders. Any information extracted from message content in which the size of the image is determined using a weight which depends upon the number of notifications relative to other notifications, previous response history, content of the notification, or the like. The electronic device 100 continuously monitors an activity of the user and updates the displayed images of the senders which are related to user activities.

Further, the proposed method provides below described advantages to the user.

By looking over the application, the user is provided with number of different users who have sent the notification.

Provide information regarding which users have sent more number of notifications than other user.

Display the image of the sender or content image to provide more information about the notification. Further, the displayed information is changed frequently over time or based on user activities if the user has not accessed the notification.

The user can directly access the notification from the particular sender.

The user can quickly view the notification content in place of an application name.

Although the electronic device 100 (for example: a mobile phone) depicted in FIG. 1A is used for implementing the proposed invention, it is to be understood that the proposed invention can be implemented in the electronic device 100 such as wearable devices (for example: a smart watch, a smart glass, a smart bracelet, or the like). An example embodiment where the proposed method implemented in the smart watch (i.e., electronic device 100) is depicted in FIG. 1B.

FIG. 1B is another example scenario in which the graphical representation 102 including the image of the sender is displayed on the smart watch (i.e., the electronic device 100) for representing the at least one notification with the application icon, according to an embodiment of the present disclosure. The smart watch can perform the functionalities of the electronic device 100 as described in FIG. 1A for managing the notifications without departing from the scope of the invention.

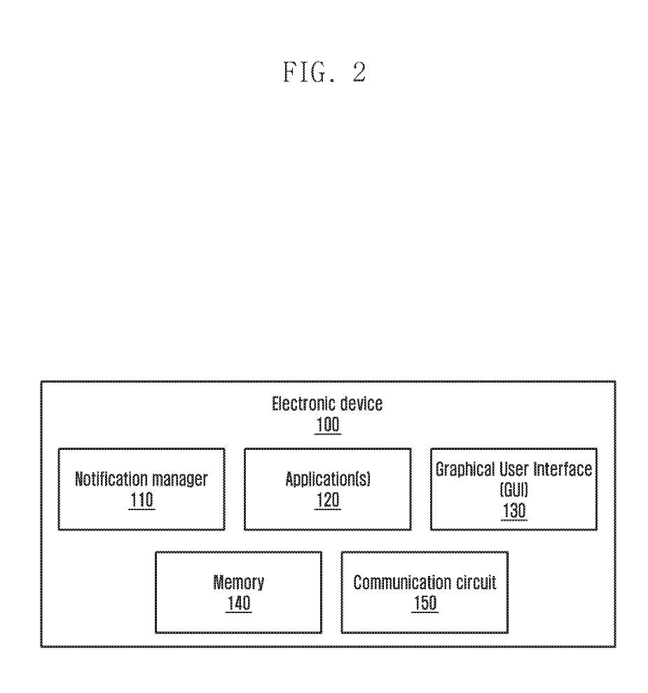

FIG. 2 illustrates a block diagram of the electronic device 100 for managing the notifications, according to an embodiment of the present disclosure. In an embodiment, the electronic device 100 can be, for example, a laptop, a desktop computer, a mobile phone, a smart phone, personal digital assistants (PDAs), a tablet, a. phablet, a consumer electronic device, a dual display device, a wearable device, or any other electronic device. In an embodiment, the electronic device 100 includes a processor 110, an application(s) 120, a graphical user interface (GUI) 130, a memory 140, and a communication circuit 150. The processor 110 may include a notification manager.

Referring to FIG. 2, the processor 110 can be configured to receive at least one notification from the plurality of senders. Further, the processor 110 can be configured to cause to display the graphical representation 102 including an identity 104 of the at least one notification from each of the sender and at least one indicator 106 indicating an identity of the application 120 corresponding to the at least one notification.

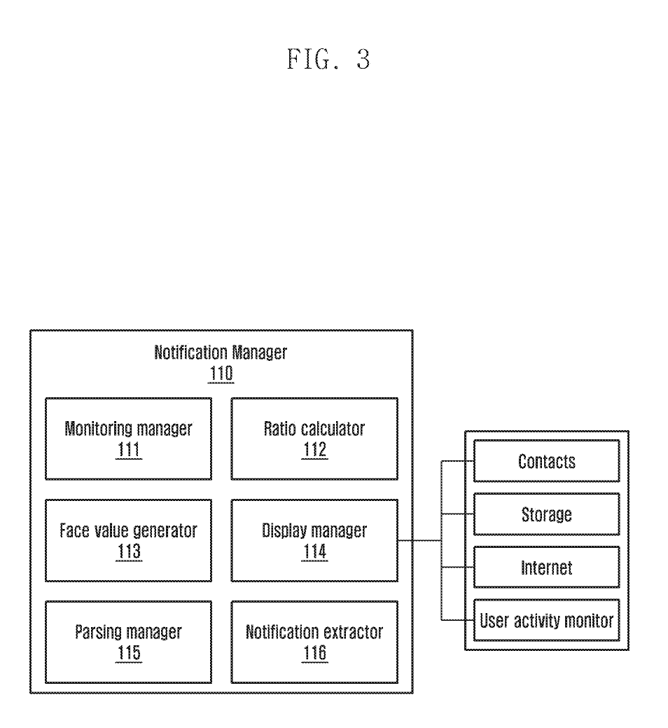

In another embodiment, the processor 110 can be configured to receive the at least one notification from the applications 120. In an example, the applications 120 can be SNS applications, messaging applications, E-mail applications, native applications available in the electronic device 100 such as call logs, play store, banking applications, shopping applications, or the like. Further, the processor 110 can be configured to cause to display the graphical representation 102 including the identity 104 of each of the application of the at least one notification and at least one indicator 106 indicating the identity of the at least one sender of the at least one notification. Further, the additional functionalities, apart from the one which are described above, of the processor 110 are explained in conjunction with FIGS. 3 to 8. In an embodiment, the GUI 130 can be configured to display the graphical representation 102.

The memory 140 may include one or more non-transitory computer-readable storage media. The memory 140 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 140 may, in some examples, be considered a non-transitory storage medium. The term “non-transitory” may indicate that the storage medium is not embodied in a carrier wave or a propagated signal. However, the term “non-transitory” should not be interpreted that the memory 140 is non-movable. In some examples, the memory 140 can be configured to store larger amounts of information than the memory. In certain examples, a non-transitory storage medium may store data that can, over time, change (e.g., in random access memory (RAM) or cache). The communication circuit 150 communicates internally with the various components of the electronic device and externally with networks.

Unlike systems and methods, the proposed method enhances the overall user experience, by dynamically managing the notifications in the electronic device 100 according to the related art. Further, the proposed method can be used to provide the image related to the sender/the notification content based on the notification ratio of the sender.

FIG. 2 shows a limited overview of the electronic device 100 but, it is to be understood that other embodiments are not limited thereto. Further, the electronic device 100 can include any number of units along with other hardware or software components communicating with each other. For example, the component can be, but not limited to, a process running in the controller or processor, an object, an executable process, a thread of execution, a program, or a computer. By way of illustration, both an application running on a device and the device itself can be a component.

FIG. 3 is an example block diagram of the processor 110, according to an embodiment of the present disclosure. In an embodiment, the processor 110 may include a notification manager and the processor 110 includes a monitoring manager 111, a ratio calculator 112, a face value generator 113, a display manager 114, a parsing manager 115, and a notification extractor 116.

Referring to FIG. 3, the monitoring manager 111 can be configured to track the notifications received in each of the application 120 from the plurality of senders (i.e., different users). The face value generator 113 can be configured to calculate the face value of the sender based on parameters such as the notification ratio. The display manager 114 can be configured to extract the images of the senders from the contacts and other images from the memory 140 or Internet as shown in FIG. 3. After extracting the images, the display manager 114 can be configured to display the notification according to the face value. Further, the display manager 114 can be configured to update the displayed images based on user activities. The parsing manager 115 can be configured to parse the information about the notification content provided to the display manager 114. The notification extractor 116 can be configured to extract the notification content and provide the extracted information to the display manager 114.

FIG. 3 shows a limited overview of the processor 110 but, it is to be understood that other embodiments are not limited thereto. Further, the processor 110 can include any number of units along with other hardware or software components communicating with each other. For example, the component can be, but not limited to, a process running in the controller or processor, an object, an executable process, a thread of execution, a program, or a computer. By way of illustration, both an application running on a device and the device itself can be a component.

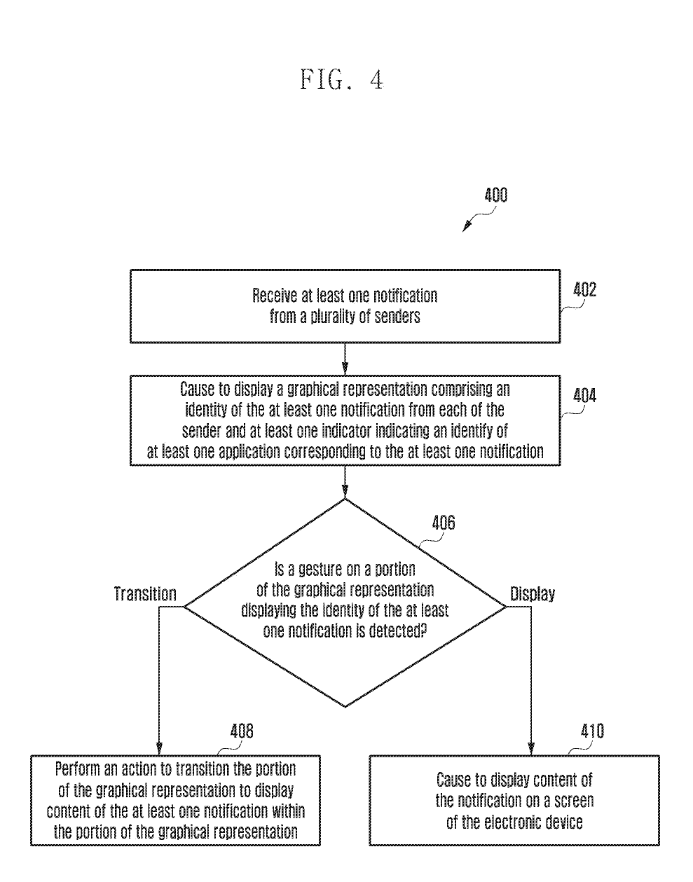

FIG. 4 is a flow chart 400 illustrating a method for managing the notifications in the electronic device 100, according to an embodiment of the present disclosure. At operation 402, the method includes receiving the at least one notification from the plurality of senders. The method allows the processor 110 to receive the at least one notification from the plurality of senders. In another embodiment, at operation 402, the method includes receiving the at least one message related to the notification from the plurality of senders. The method allows the processor 110 to receive the at least one message related to the notification from the plurality of senders. At operation 404, the method includes causing to display the graphical representation 102 including the identity 104 of the at least one notification from each of the sender and the at least one indicator 106 indicating the identity of the application 120 corresponding to the at least one notification.

In an example, the identity 104 of the at least one notification from each of the sender is dynamically updated based on activities of the user of the electronic device 100. In an example, the identity 104 for each of the notification to be displayed is automatically defined based on the plurality of parameters including at least one of a sender of the notification, content of the notification, the user activities, a location of the user of the electronic device 100, a location of the sender, a category of the notification, a degree of closeness, or a communication history of the user. In an example, the identity 104 to be displayed is defined based on the face value, where the face value is defined based on at least one of the number of notifications, the sender of the notification, the content of the notification, the user activities, the location of the user of the electronic device 100, the location of the sender, the category of the notification, the degree of closeness, or the communication history.

In an example, the identity 104 of the at least one notification includes at least one of a thumbnail image of the at least one sender of the at least one notification, a name of the at least one sender of the at least one notification, a descriptor of the content of the at least one notification, or a user defined identifier for the at least one notification. In an example, the identity of the at least one application includes at least one of an image icon of the application 120 corresponding to the at least one notification, a name of the application 120 corresponding to the at least one notification, or a user defined identifier for the application 120 corresponding to the at least one notification. In an example, the identity 104 of the at least one notification from each of the sender is scrolled based on a gesture performed on the graphical representation 102. In another example, the identity 104 of the at least one notification from each of the sender is changed based on a gesture performed on the graphical representation 102. In another example, the identity 104 of the at least one notification from each of the sender is changed based on a user input performed on the graphical representation 102.

In an embodiment, at operation 406, if it is determined that the gesture is performed on a portion of the graphical representation 102 displaying the identity 104 of the at least one notification then, at operation 408, the method includes performing an action to transition the portion of the graphical representation 102 to display the content of the at least one notification within the portion of the graphical representation 102. The method allows the processor 110 to perform the action to transition the portion of the graphical representation 102 to display content of the at least one notification within the portion of the graphical representation 102.

In another embodiment, at operation 406, if it is determined that the user input is performed on a portion of the graphical representation 102 displaying the identity 104 of the at least one notification then, at operation 408, the method includes performing an action to transition the portion of the graphical representation 102 to display the content of the at least one notification within the portion of the graphical representation 102. The method allows the processor 110 to perform the action to transition the portion of the graphical representation 102 to display content of the at least one notification within the portion of the graphical representation 102. The user input can be a touch input, a hover input, a swipe input, a drag and drop input, a key input, a dial input, a bezel rotation input or the like.

In another embodiment, at operation 406, if it is determined that the gesture is performed on the portion of the graphical representation 102 displaying the identity 104 of the at least one notification to display the content then, at operation 410, the method includes causing to display the content of the notification on the screen (i.e., GUI 130) of the electronic device 100. The method allows the processor 110 to cause to display the content of the notification on the screen of the electronic device 100.

In another embodiment, at operation 406, if it is determined that the user input is performed on the portion of the graphical representation 102 displaying the identity 104 of the at least one notification to display the content then, at operation 410, the method includes causing to display the content of the notification on the screen (i.e., GUI 130) of the electronic device 100. The method allows the processor 110 to cause to display the content of the notification on the screen of the electronic device 100.

The various actions, acts, blocks, operations, or the like in the flow chart 400 may be performed in the order presented, in a different order or simultaneously. Further, in some embodiments, some of the actions, acts, blocks, operations, or the like may be omitted, added, modified, skipped, or the like without departing from the scope of the invention.

FIG, 5 is a flow chart 500 illustrating a method for displaying the identity 104 after detecting a gesture performed by the user to mode the graphical representation 102, according to an embodiment of the present disclosure. At operation 502, the method includes receiving the at least one notification from the at least one sender. The method allows the processor 110 to receive the at least one notification from the at least one sender. At operation 502, the method includes receiving the at least one message related to the notification from the at least one sender. The method allows the processor 110 to receive the at least one notification from the at least one sender.

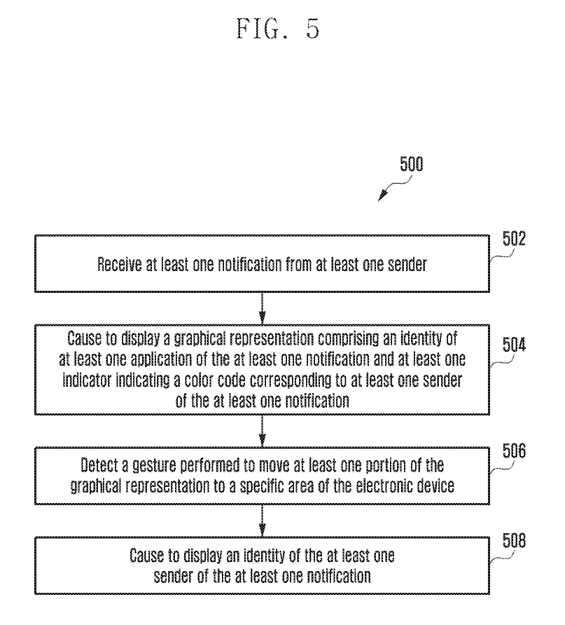

Referring to FIG. 5, at operation 504, the method includes causing to display the graphical representation 102 including the identity 104 of the application 120 of the at least one notification and the at least one indicator 106 indicating a color code corresponding to the at least one sender of the at least one notification. The method allows the processor 110 to cause to display the graphical representation 102 including the identity 104 of the at least one application of the at least one notification and the at least one indicator 106 indicating the color code corresponding to the at least one sender of the at least one notification. In an example, the identity 104 of the application 120 includes at least one of the image icon of the at least one application corresponding to the at least one notification, the name of the at least one application corresponding to the at least one notification, or the user defined identifier for the application 120 corresponding to the at least one notification.

At operation 506, the method includes detecting the gesture performed by the user to move at least one portion of the graphical representation 102 to a specific area (i.e., an edge portion) of the electronic device 100. The method allows the processor 110 to detect the gesture performed to move the at least one portion of the graphical representation 102 to the specific area of the electronic device 100.

In another embodiment, at operation 506, the method includes detecting the user input performed by the user to move at least one portion of the graphical representation 102 to a specific area (i.e., an edge portion) of the electronic device 100. The method allows the processor 110 to detect the user input performed to move the at least one portion of the graphical representation 102 to the specific area of the electronic device 100.

At operation 508, the method includes causing to display the identity of the at least one sender of the at least one notification. The method allows the processor 110 to cause to display the identity of the at least one sender of the at least one notification.

The various actions, acts, blocks, operations, or the like in the flow chart 500 may be performed in the order presented, in a different order or simultaneously. Further, in some embodiments, some of the actions, acts, blocks, operations, or the like may be omitted, added, modified, skipped, or the like without departing from the scope of the invention.

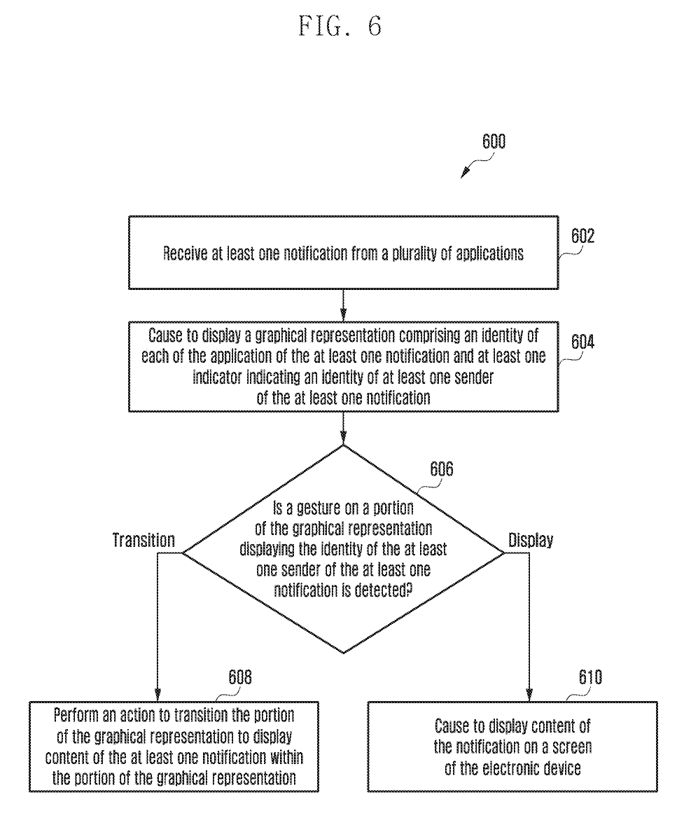

FIG. 6 is a flow chart 600 illustrating a method for managing the notifications in the electronic device 100, according to an embodiment of the present disclosure. At operation 602, the method includes receiving the at least one notification from the application 120. The method allows the processor 110 to receive the at least one notification from the application 120.

Referring to FIG. 6, at operation 602, the method includes receiving the at least one message related to a notification from the application 120. The method allows the processor 110 to receive the at least one notification from the application 120.

At operation 604, the method includes causing to display the graphical representation 102 including the identity 104 of each of the application of the at least one notification and the at least one indicator 106 indicating the identity of the at least one sender of the at least one notification. The method allows the processor 110 to cause to display the graphical representation 102 including the identity 104 of each of the application of the at least one notification and the at least one indicator 106 indicating the identity of the at least one sender of the at least one notification.

In an example, the identity of the at least one sender of the at least one notification is dynamically updated based on activities of the user of the electronic device 100. In an example, the identity of the at least one sender of the at least one notification to be displayed is automatically defined based on the plurality of parameters including at least one of the sender of the notification, the content of the notification, the user activities, the location of the user of the electronic device 100, the location of the sender, the category of the notification, the degree of closeness, or the communication history.

In an example, the face value of the identity to be displayed is defined based on the notification ratio, where the notification ratio is defined based on at least one of the number of notifications, the sender of the notification, the content of the notification, the user activities, the location of the user, the category of the notification, the degree of closeness, or the communication history. In an example, the identity of each of the application includes at least one of the image icon of the at least one application corresponding to the at least one notification, the name of the at least one application corresponding to the at least one notification, or the user defined identifier for the at least one application corresponding to the at least one notification.

In an example, the identity of the at least one sender includes at least one of the thumbnail image of the at least one sender of the at least one notification, the name of the at least one sender of the at least one notification, the descriptor of the content of the at least one notification, or the user defined identifier for the at least one notification. In an example, the identity of the at least one sender of the at least one notification is scrolled based on the gesture performed by the user on the graphical representation 102

In an embodiment, at operation 606, if it is determined that the gesture is performed on the portion of the graphical representation 102 displaying the identity of the at least one sender of the at least one notification then, at operation 608, the method includes performing the action to transition the portion of the graphical representation 102 to display the content of the at least one notification within the portion of the graphical representation 102. The method allows the processor 110 to perform the action to transition the portion of the graphical representation 102 to display the content of the at least one notification within the portion of the graphical representation 102.

In another embodiment, at operation 606, if it is determined that the user input is performed on the portion of the graphical representation 102 displaying the identity of the at least one sender of the at least one notification then, at operation 608, the method includes performing the action to transition the portion of the graphical representation 102 to display the content of the at least one notification within the portion of the graphical representation 102. The method allows the processor 110 to perform the action to transition the portion of the graphical representation 102. to display the content of the at least one notification within the portion of the graphical representation 102

In another embodiment, at operation 606, if it is determined that the gesture is performed on the portion of the graphical representation 102 displaying the identity of the at least one sender of the at least one notification then, at operation 610, the method includes causing to display the content of the notification on the screen of the electronic device 100. The method allows the processor 110 to cause to display the content of the notification on the screen of the electronic device 100.

In another embodiment, at operation 606, if it is determined that the user input is performed on the portion of the graphical representation 102 displaying the identity of the at least one sender of the at least one notification then, at operation 610, the method includes causing to display the content of the notification on the screen of the electronic device 100. The method allows the processor 110 to cause to display the content of the notification on the screen of the electronic device 100.

The various actions, acts, blocks, operations, or the like in the flow chart 600 may be performed in the order presented, in a different order or simultaneously. Further, in some embodiments, some of the actions, acts. blocks, operations, or the like may be omitted, added, modified, skipped, or the like without departing from the scope of the invention.

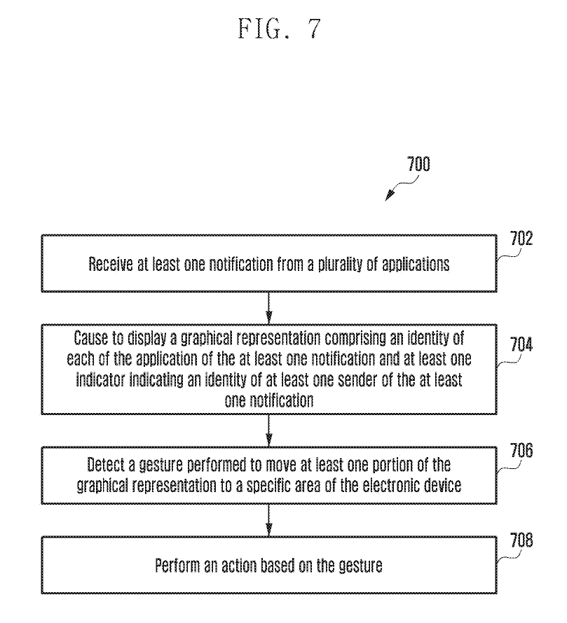

FIG. 7 is a flow chart 700 illustrating a method for performing an action based on the gesture performed by the user to move the at least one portion of the graphical representation 102, according to an embodiment of the present disclosure. At operation 702, the method includes receiving the at least one notification from the application 120. The method allows the processor 110 to receive the at least one notification from the application 120.

Referring to FIG. 7, at operation 702, the method includes receiving the at least one message related to a notification from the application 120. The method allows the processor 110 to receive the at least one notification from the application 120.

At operation 704, the method includes causing to display the graphical representation 102 including the identity 104 of each of the application of the at least one notification and the at least one indicator 106 indicating the identity of the at least one sender of the at least one notification. The method allows the processor 110 to cause to display the graphical representation 102 including the identity of each of the application of the at least one notification and the at least one indicator 106 indicating the identity of the at least one sender of the at least one notification.

At operation 706, the method includes detecting the gesture performed to move the at least one portion of the graphical representation 102 to the specific area of the electronic device 100. The method allows the processor 110 to detect the gesture performed to move the at least one portion of the graphical representation 102 to the specific area of the electronic device 100. At operation 708, the method includes performing the action based on the gesture. The method allows the processor 110 to perform the action based on the gesture. In an example, the action can be displaying the content of the notification within the portion of the graphical representation 102.

In another embodiment, at operation 706, the method includes detecting the user input performed to move the at least one portion of the graphical representation 102 to the specific area of the electronic device 100. The method allows the processor 110 to detect the user input performed to move the at least one portion of the graphical representation 102 to the specific area of the electronic device 100. At operation 708, the method includes performing the action based on the gesture. The method allows the processor 110 to perform the action based on the user input. In an example, the action can be displaying the content of the notification within the portion of the graphical representation 102.

The various actions, acts, blocks, operations, or the like in the flow chart 700 may be performed in the order presented, in a different order or simultaneously. Further, in sonic embodiments, sonic of the actions, acts, blocks, operations, or the like may be omitted, added, modified, skipped, or the like without departing from the scope of the invention.

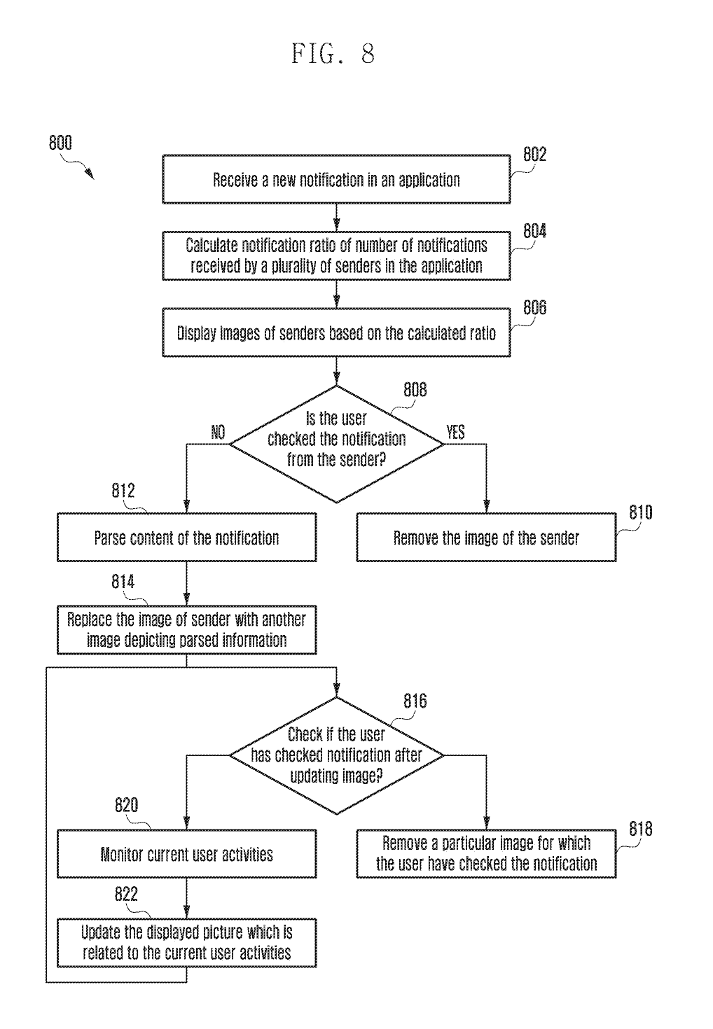

FIG. 8 is a flow chart 800 illustrating the overall proposed method for managing the notification in the electronic device 100 and updating the image of the sender based on the user activities, according to an embodiment of the present disclosure. At operation 802, the method includes receiving a new notification in the application 120. The method allows the processor 110 to receive the new notification in the application 120. In an example, the application 120 can be the SNS applications, the messaging applications, the E-mail applications, the native applications available in the electronic device 100 such as the call logs, the play store, the banking applications, the shopping applications, or the like.

Referring to FIG. 8, at operation 802, the method includes receiving a new message related to a notification in the application 120. The method allows the processor 110 to receive the new notification in the application 120.

At operation 804, the method includes calculating the notification ratio of the number of notifications received by different users in the application 120. The method allows the processor 110 to calculate the notification ratio of the number of notifications received from the plurality of senders in the application 120.

In another embodiment, at operation 804, the method includes calculating the notification ratio of the number of messages received by different users in the application 120. The method allows the processor 110 to calculate the notification ratio of the number of messages received from the plurality of senders in the application 120.

At operation 806, the method includes displaying the images of the senders based on the calculated notification ratio. The method allows the processor 110 to display the images of the senders based on the calculated notification ratio.

At operation 808, if it is determined that the user has checked the notification received from the sender then, at operation 810, the method includes removing the image of the sender. The method allows the processor 110 to remove the image of the sender. At operation 808, if it is determined that the user has not checked the notification received from the sender then, at operation 812, the method includes parsing the content of the notification. The method allows the processor 110 to parse the content of the notification.

In another embodiment, at operation 806, if it is determined that the user has checked the message received from the sender then, at operation 810, the method includes removing the image of the sender. The method allows the processor 110 to remove the image of the sender. At operation 806, if it is determined that the user has not checked the message received from the sender then, at operation 812, the method includes parsing the content of the message. The method allows the processor 110 to parse the content of the message.

At operation 814, the method includes replacing the image of the sender with another image depicting the parsed information of the notification content. The method allows the processor 110 to replace the image of the sender with another image depicting the parsed information. At operation 816, if it is determined that the user has checked the notification after updating the image with the parsed information then, at operation 818, the method includes removing a particular image for which the user have checked the notification. The method allows the processor 110 to remove the particular image for which the user has checked the notification.

In another embodiment, at operation 814, the method includes replacing the image of the sender with another image depicting the parsed information of the message content. The method allows the processor 110 to replace the image of the sender with another image depicting the parsed information. At operation 816, if it is determined that the user has checked the message after updating the image with the parsed information then, at operation 818, the method includes removing a particular image for which the user have checked the message. The method allows the processor 110 to remove the particular image for which the user has checked the message.

At operation 816, if it is determined that the user has not checked the notification after updating the image then, at operation 820, the method includes monitoring the current activities of the user. The method allows the processor 110 to monitor the current user activities. At operation 822, the method includes updating the displayed image which is related to the current user activities and looped to operation 816. The method allows the processor 110 to update the displayed image which is related to the current user activities and looped to operation 816.

In another embodiment, at operation 816, if it is determined that the user has not checked the message after updating the image then, at operation 820, the method includes monitoring the current activities of the user. The method allows the processor 110 to monitor the current user activities. At operation 822, the method includes updating the displayed image which is related to the current user activities and looped to operation 816. The method allows the processor 110 to update the displayed image which is related to the current user activities and looped to operation 816.

The various actions, acts, blocks, operations, or the like in the flow chart 800 may be performed in the order presented, in a different order or simultaneously. Further, in some embodiments, some of the actions, acts, blocks, operations, or the like may be omitted, added, modified, skipped, or the like without departing from the scope of the invention.

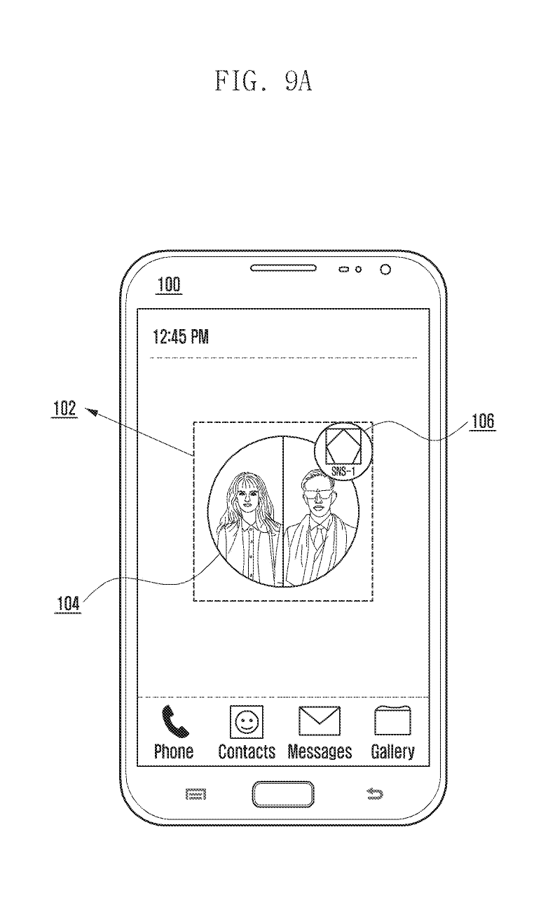

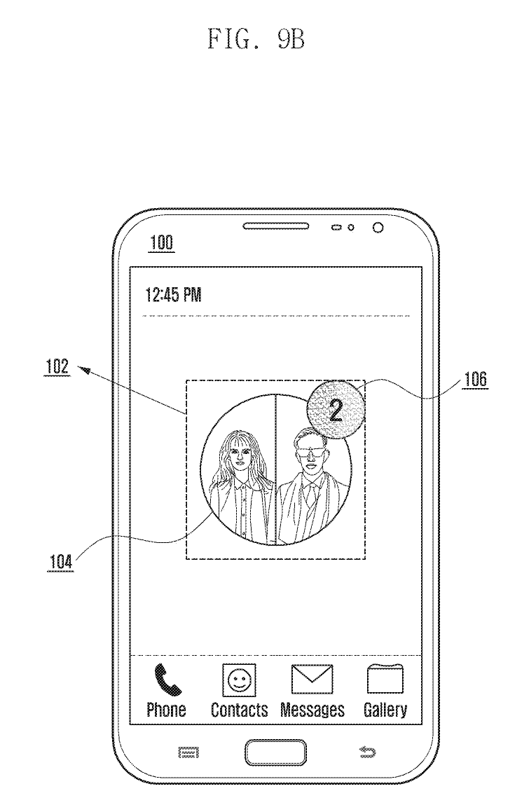

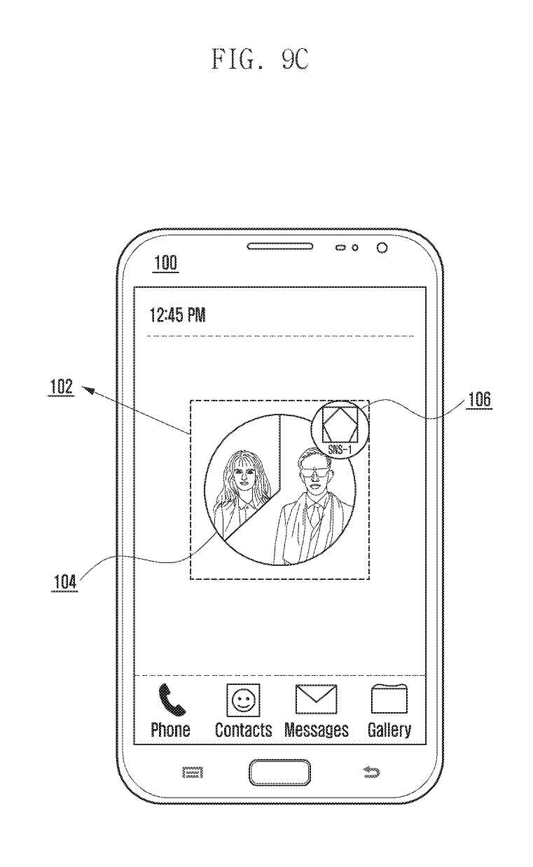

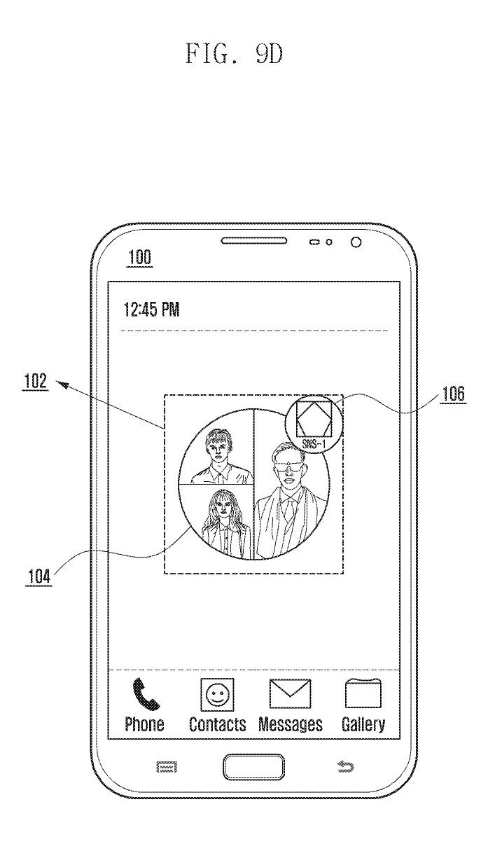

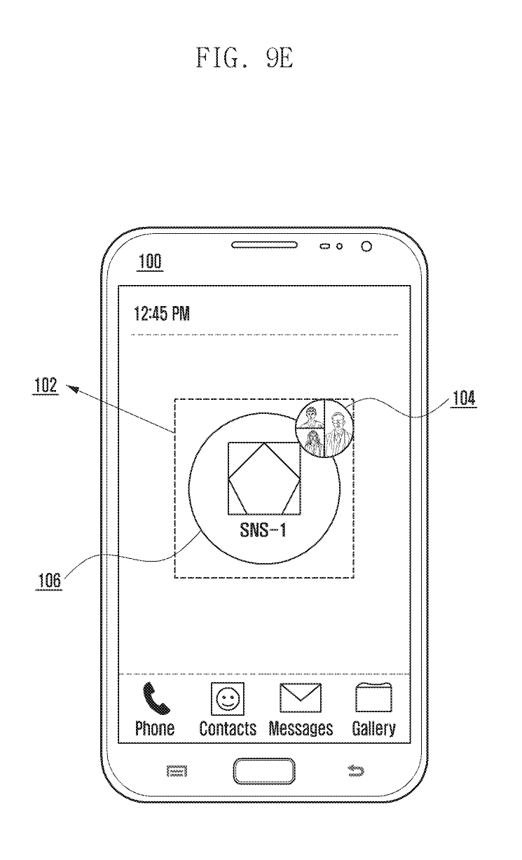

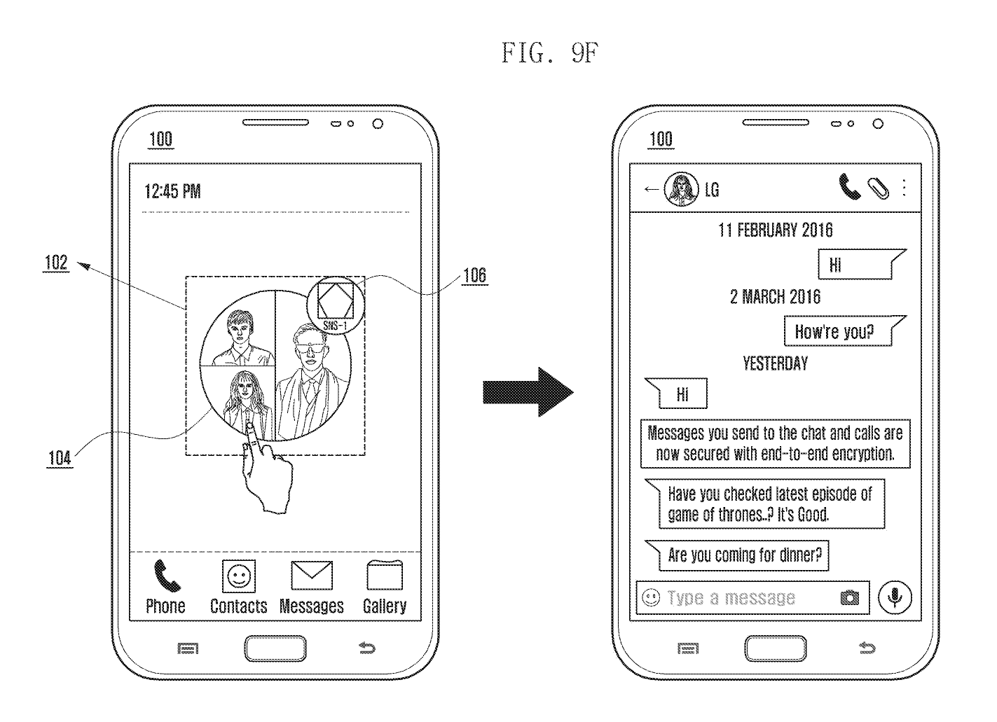

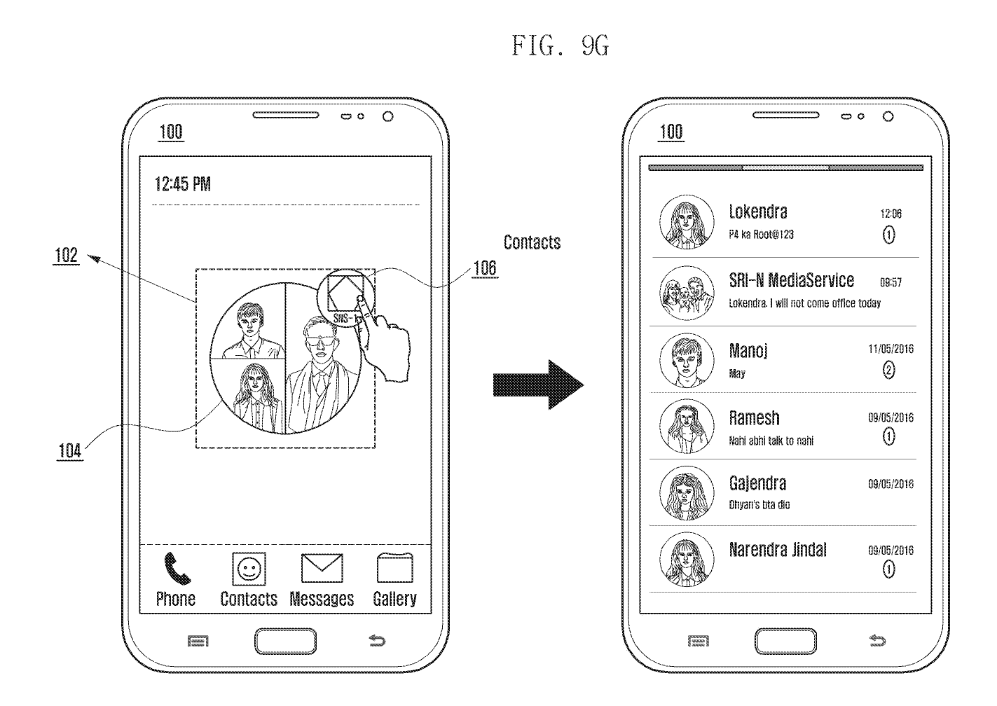

FIG. 9A is an example illustration in which the graphical representation 102 including the identity 104 of two notifications from each of the sender and the indicator 106 indicating the identity of the application corresponding to the two notifications is displayed on the electronic device 100, according to an embodiment of the present disclosure. Consider a scenario where the user receives the two notifications one from each of the senders in the application. The indicator 106 includes at least one a name of the application and a representation image of the application. After receiving the two notifications, the notification manger 110 causes to display the graphical representation 102 on the screen of the electronic device 100 as shown in FIG. 9A.

As the user received two messages one from each of the senders, the processor 110 determines the notification ratio as 1:1. As shown in FIG. 9A, the graphical representation 102 includes the thumbnail image of the senders of the two notifications (i.e., identity 104 of the at least one notification); and combination of the image icon of the application corresponding to the notifications and the name of the application corresponding to the notifications indicator 106). As the notification ratio is 1:1, the size of the image of each of the senders is in equal ratio as shown in FIG. 9A.

FIG, 9B is an example scenario in which the graphical representation 102 including the thumbnail image of the senders of the two notifications and the number of notifications with a color code is displayed on the electronic device 100, according to an embodiment as disclosed herein. Consider a scenario where the user receives the two notifications one from each of the senders. After receiving the notifications, the processor 110 causes to display the graphical representation 102 on the screen of the electronic device 100 as shown in FIG. 9B.

As the user received two messages one from each of the senders, the processor 110 determines the notification ratio as 1:1. Here, the notification ratio is calculated each sender with respect to all other senders within the application. Based on the notification ratio calculated, the processor 110 fetches the images of the senders from the contacts and generates the pie chart in which the particular sender image size depends on the notification ratio.

As shown in FIG. 9B, the graphical representation 102 includes the thumbnail image of the senders of the two notifications; and the number of notifications with the color code. Here, the number of notifications (i.e., 2) with two colors indicates the user that he/she has received the notifications from two senders. Further, two colors are indicated with an equal color ratio thus indicating same number of notifications from each of the senders as shown in FIG. 9B.

FIG. 9C is an example scenario in which the notification ratio is changed when the user receives a new notification from the previous sender, according to an embodiment of the present disclosure. Consider a scenario where the user receives the new notification from one of the previous sender. After receiving the new notification, the processor 110 re-calculates the notification ratio to determine the size of the image of each of the senders to he displayed on the screen of the electronic device 100. As the new notification is received from the previous sender, the processor 110 calculates the notification ratio as 1:2. As the notification ratio is 1:2. The size of one of the image is more when compared to the size of the other image as shown in FIG. 9C. The image with more size indicates the user, that two notifications are received from that sender.

FIG. 9D is an example scenario in which the graphical representation 102 is changed to include an additional image of a new sender after receiving the new notification from the new sender, according to an embodiment of the present disclosure. Consider a scenario where the user receives the new notification from the new sender. After receiving the new notification from the new sender, the processor 110 re-calculates the notification ratio to determine the size of the image of each of the senders to be displayed on the screen of the electronic device 100. As the new notification is received from the new sender, the processor 110 calculates the notification ratio as 1:1:2. As per the notification ratio, the size of the image of each of the senders is displayed on the screen of the electronic device 100.

Referring to FIG. 9D, the graphical representation 102 includes the thumbnail image of the three senders of the three notifications (i.e., identity 104 of the at least one notification); and combination of the image icon of the application corresponding to the notifications and the name of the application corresponding to the notifications (i.e., indicator 106).

FIG. 9E is an example scenario in which a view of the graphical representation 102 displayed on the electronic device 100 is changed by the user, according to an embodiment of the present disclosure. As shown in FIG. 9E, the changes view of the graphical representation 102 includes the identity 104 of the application of the notifications and the indicator 06 indicating the identity 104 of the senders of the notifications.

FIG. 9F is an example scenario in which the content of the notification is displayed on the screen of the electronic device 100, according to an embodiment of the present disclosure. As shown in FIG. 9F, the user performs the gesture of the portion of the graphical representation 102 displaying the identity 104 of the notifications. After detecting the gesture, the processor 110 causes to display the content of the notification on the screen of the electronic device 100. Therefore, the user can directly access the notification from that sender by performing a touch input on that sender as shown in FIG. 9F.

FIG. 9G is an example scenario in which the home page of the application is launched and displayed on the screen of the electronic device 100, according to an embodiment of the present disclosure. As shown in FIG. 9G, the user performs the gesture on the icon of the application. After detecting the gesture, the processor 110 launches the home page of the application and displays the home page on the screen of the electronic device 100. Therefore, the user can directly launch the home page of the application by performing the touch input on that sender as shown in FIG. 9G.

In methods, there are many third party applications available which count and display the number of un-read notifications according to the related art. In the proposed method, the processor 110 calculates the notification ratio and use different color and images to display the graphical representation 102 on the screen of the electronic device 100.

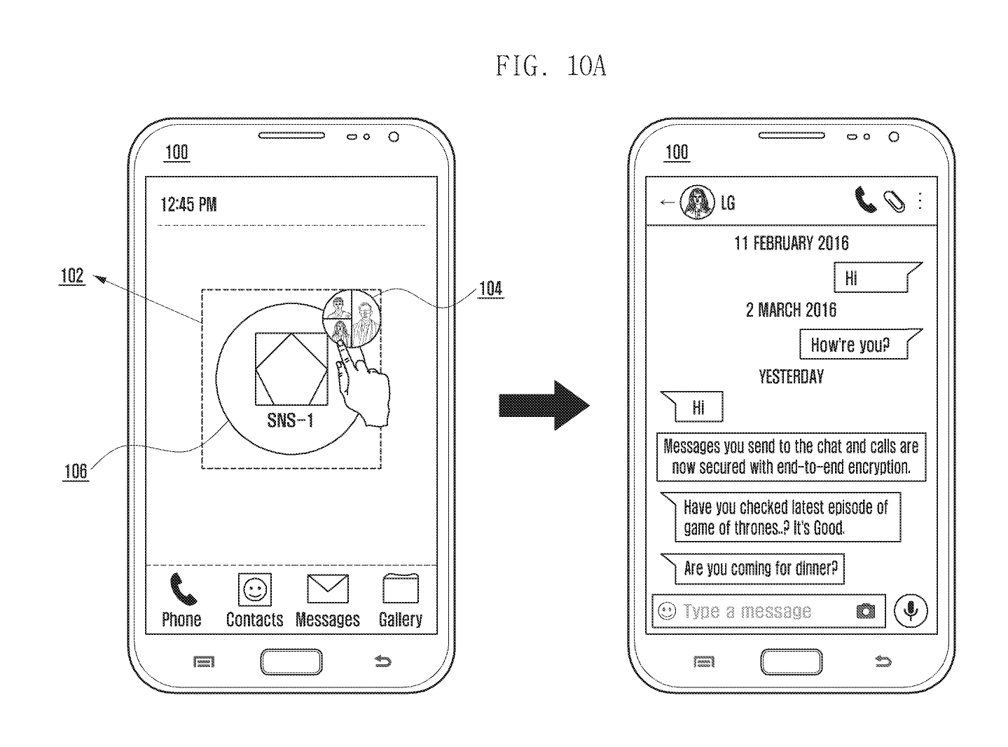

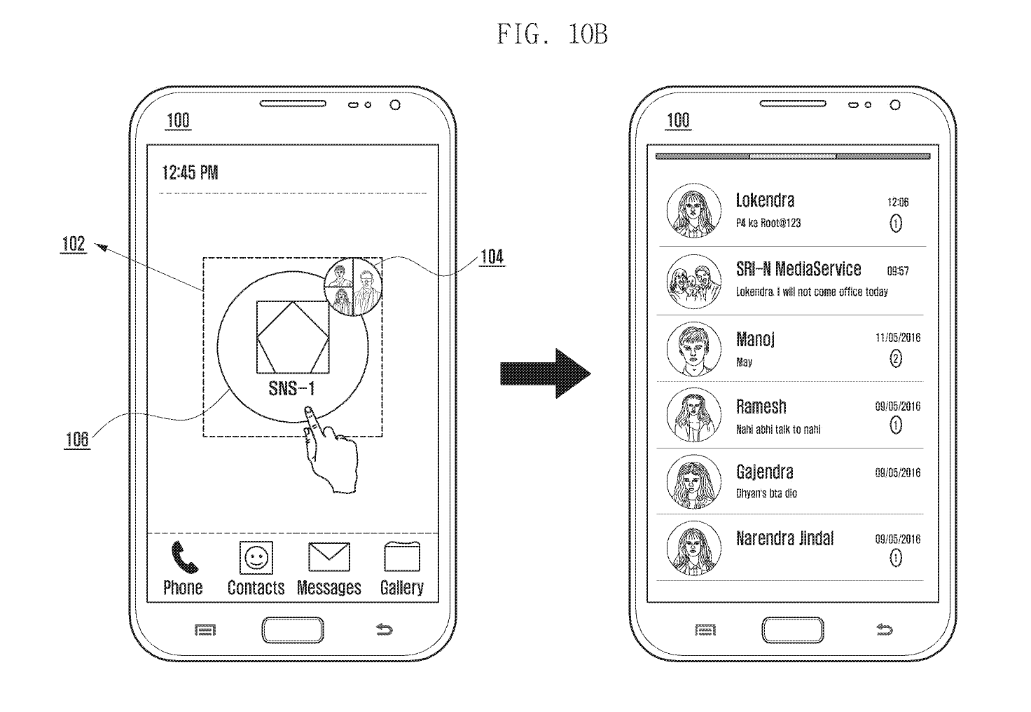

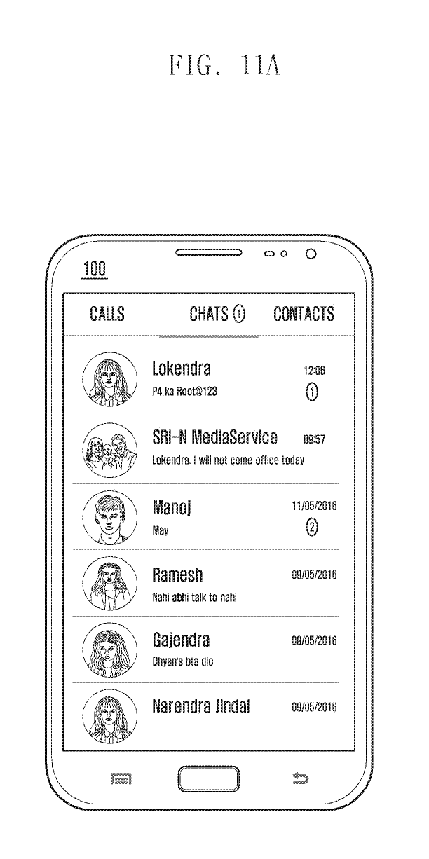

FIG. 10A is an example scenario in which the content of the notification is displayed on the screen of the electronic device 100 after detecting the gesture performed by the user on the image of the sender, according to an embodiment of the present disclosure. Consider a scenario where the user receives the four notifications from the senders in the application. After receiving the four notifications, the notification manger 110 causes to display the graphical representation 102 on the screen of the electronic device 100 as shown in FIG. 10A.

As the user received four messages, the processor 110 determines the notification ratio as 1:1:2. As shown in FIG. 10A, the graphical representation 102 includes the identity 104 of the application of the notifications (i.e., combination of the image icon of the application corresponding to the notifications and the name of the application corresponding to the notifications) and the indicator 106 indicating the identity of the senders of the notifications (i.e., the thumbnail image of the senders of the notifications).

Further, as shown in FIG. 10A, the user performs the gesture on the portion of the graphical representation 102 displaying the thumbnail image of the senders of the notifications. After detecting the gesture, the processor 110 causes to display the content of the notification on the screen of the electronic device 100. Therefore, the user can directly access the notification from the particular sender by performing the touch input on that sender as shown in FIG. 10A.

FIG. 10B is an example scenario in which the home page of the application is displayed on the screen of the electronic device 100, according to an embodiment of the present disclosure. As shown in FIG. 10B, the user performs the gesture on the icon of the application. After detecting the gesture, the processor 110 launches the home page of the application and displays the home page on the screen of the electronic device 100. Therefore, the user can directly launch the home page of the application by performing the touch input on that sender as shown in FIG. 10B.

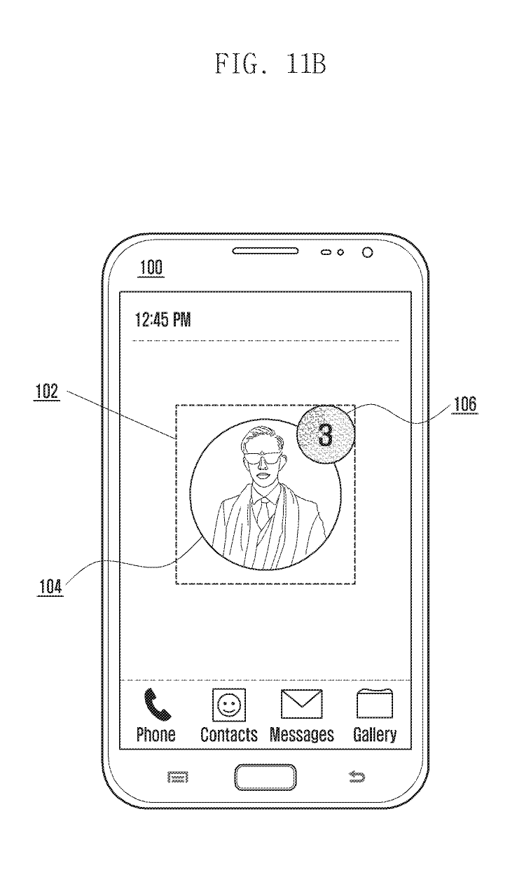

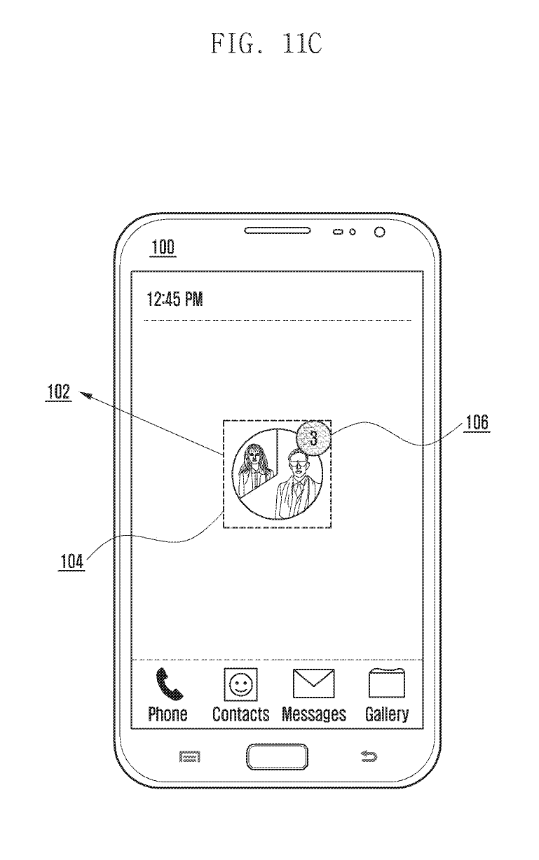

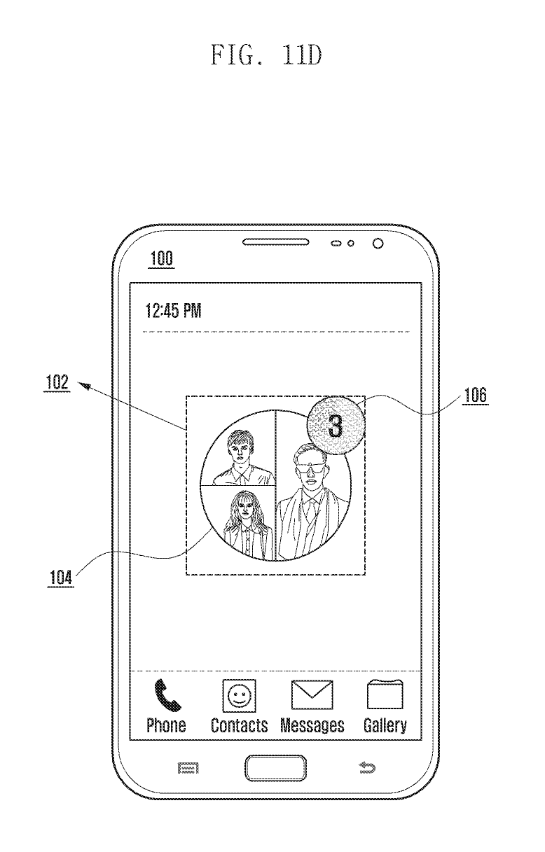

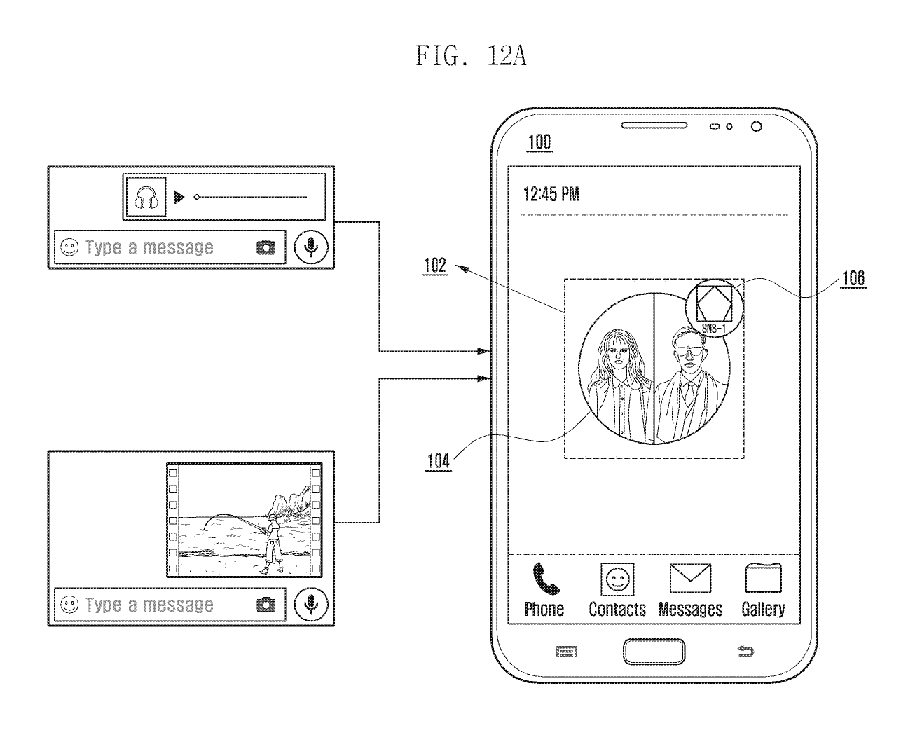

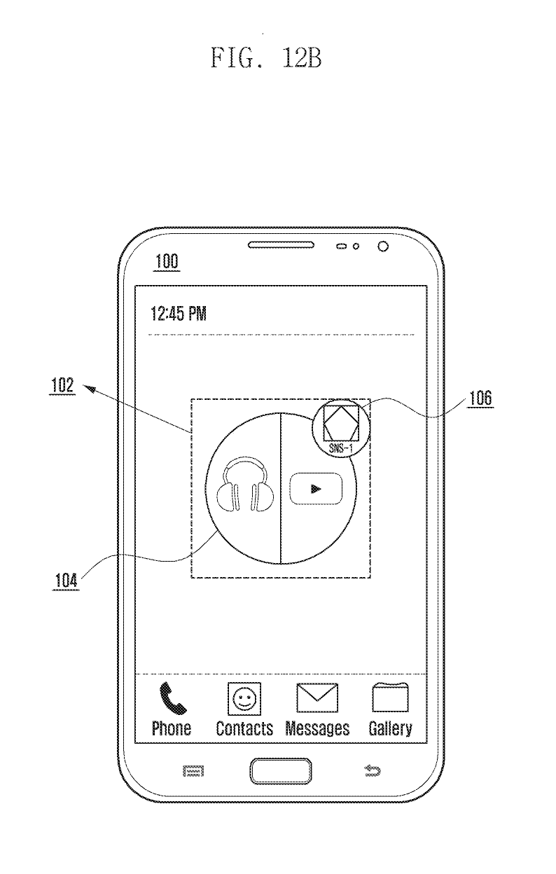

FIG. 11A is an example scenario in which the home page of the application is displayed on the screen of the electronic device 100, according to an embodiment of the present disclosure. Initially, consider a scenario where the user receives the three notifications from the senders. The home page of the application indicating the number of notifications received from each of the sender is displayed on the screen of the electronic device 100 as shown in FIG. 11A.

FIG. 11B is an example scenario in which the graphical representation 102 including the thumbnail image of only one sender with small size is displayed on the screen of the electronic device 100, according to an embodiment of the present disclosure. Consider a scenario where the user receives three notifications from the two senders. As shown in FIG. 11B, if the graphical representation 102 is displayed in the small size then, the image of the sender who has sent two notifications is displayed within the graphical representation 102 along with the number of notifications with the color code. For example, the processor 110 tracks the size of the graphical representation 102. If the size is small then only one sender image is displayed but later the size of the graphical representation 102 can be increased to include more number of sender images.

FIG. 11C is an example scenario in which the size of the graphical representation 102 is increased to display more number of senders, according to an embodiment of the present disclosure. For example, the processor 110 determines the size of the graphical representation 102 i.e., whether the size of the graphical representation 102 is small/medium or large. Further, the processor 110 can automatically increase the size of the graphical representation 102. To display more number of images of the senders if the number of senders is more. The user is also provided with an option to change the size of the graphical representation 102 manually. As shown in FIG. 11C, same color code is used such that the user can correlate the image of the sender with the number of notifications which they sent to the user.

FIG. 11D is an example scenario in which a grid size of the graphical representation 102 is changed by the user, according to an embodiment of the present disclosure. As shown in FIG. 11D, the user performs the gesture to select an appropriate grid size. If the user selects the grid size of “4×4” as shown in FIG. 11D, the size of the graphical representation 102 is increased to display more number of images of the senders as shown in FIG. 11D. FIG. 11D is an example scenario in which the increased graphical representation 102 is displayed on the screen of the electronic device 100.

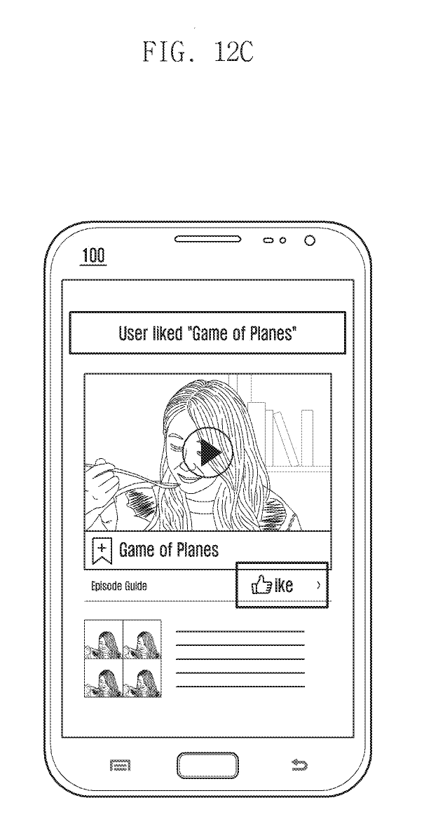

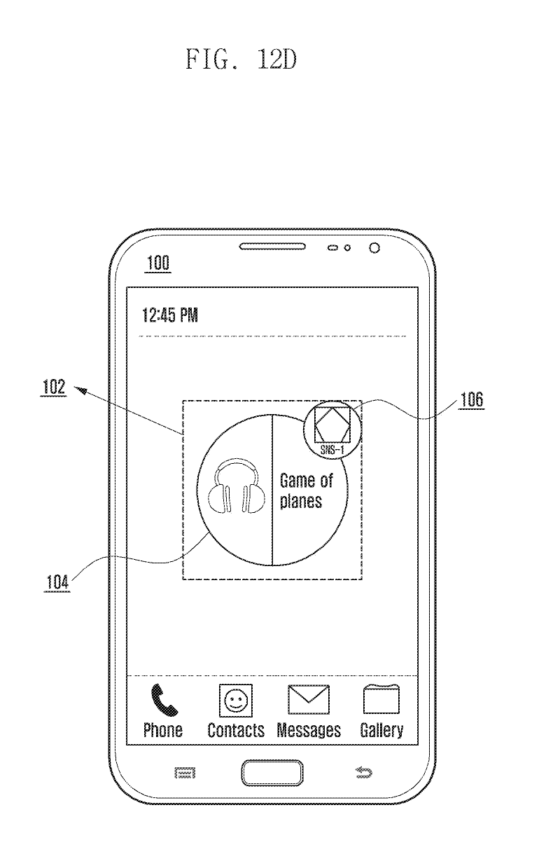

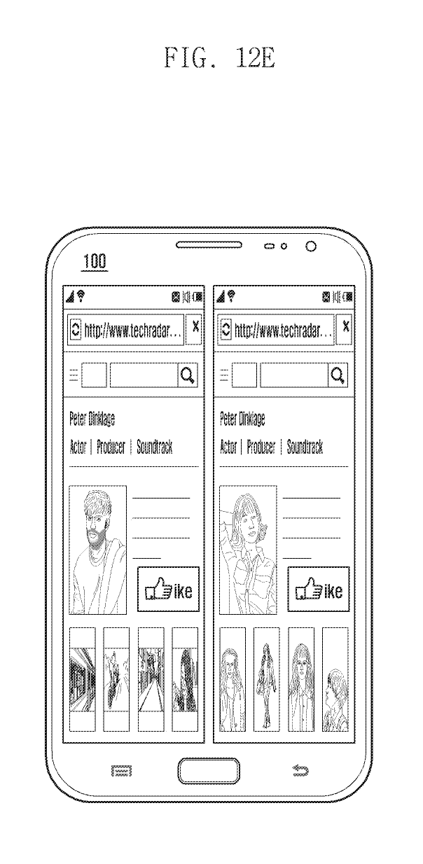

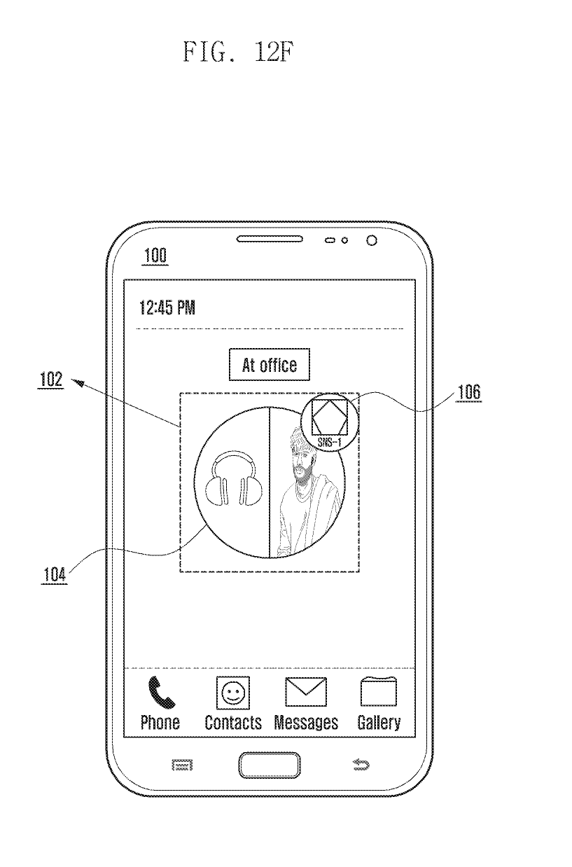

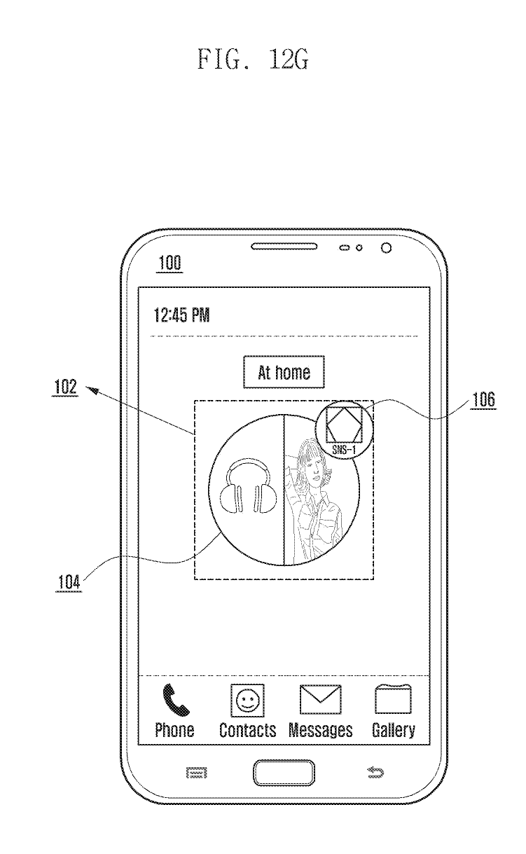

FIGS. 12A to 12G are example scenarios in which the identity 104 of the notifications from each of the sender is dynamically updated based on the user activities, according to an embodiment of the present disclosure. Consider a scenario where the user receives two notifications, one from each of the sender. One notification is an audio notification and other one is a video notification which is a trailer of new episode of “Game of planes”.

Referring to FIGS. 12A to 12G, after receiving the two notifications, the processor 110 causes to display the graphical representation 102 including the thumbnail image of the senders of the two notifications; and combination of the image icon of the application and name of the application corresponding to the notifications. As the notification ratio is 1:1, the size of the image of each of the senders is in equal ratio as shown in FIG. 12A.

Further, if the user is not interested in the sender information and not checked the notification then, the user is provided with more information. The thumbnail of the audio notification and the thumbnail of the video notifications are displayed in place of the image of the senders as shown in FIG. 12B. In an example, the image of the senders can be changed (i.e., automatically or manually by the user) after a certain time period or based on a scroll action performed on the graphical representation 102 by the user. Initially, by default, the images of the senders are displayed to the user and based on the scroll action performed by the user; more information is displayed to the user.

Further, consider a scenario where the user not checked the notification received from the particular sender and performed another activity in which the user liked “Game of planes” television (TV) series as shown in FIG. 12C. After detecting that the user has liked the “Game of planes” TV series (i.e., video), the processor 110 parses the notification contents and detects that the video is related to the “Game of planes” TV series and changes the image of the sender to replace it with the video image of the “Game of planes” TV series as shown in FIG. 12D. Further, the processor 110 monitors the user activities and determines that the user have liked it on another application when the user checks the application. The user knows and correlates with the notification content. Thus, increasing the probability of checking the notifications by the user. Further, the processor 110 monitors the user activities and accordingly updates the images of the senders.

Further, the user not checked the notification received from the particular sender and performed another activity in which the user liked characters of the “Game of planes” TV series as shown in FIG. 12E. The image of the sender is changed to display the characters of the “Game of planes” TV series based on the location of the user. At office, the video image of the “Game of planes” TV series is replaced with the character of the “Game of planes” TV series as shown in FIG. 12F. Further, at home, the video image of the “Game of planes” TV series is replaced with another character of the “Game of planes” TV series as shown in FIG. 12G.

FIG. 13 is an example scenario in which the graphical representation 102 including the identity 104 depicting the received notification content and the indicator 106 indicating the identity of the sender of the notification, according to an embodiment of the present disclosure. Consider a scenario where the user receives the notifications (i.e., messages) in the “Messenger App” from the sender. After receiving the notifications, the processor 110 parses the notification content using the methods for the particular sender according to the related art. The notification content is about “Game of planes” and dinner. This notification content is used to display the images within the application as shown in FIG. 13.

Referring to FIG. 13, to display the images, the processor 110 uses the existing images available in the memory 140 or downloads from the Internet depicting the received notification content (i.e., topic). The processor 110 displays the images in the ratio calculated based on the number of notifications received specific to particular content (i.e., two notifications depicting two different topics) as shown in FIG. 13.

FIG. 14 is an example scenario in which the graphical representation 102 including emoticons to display notification context; and the image icon and name of the application, according to an embodiment of the present disclosure. Consider a scenario where the user receives the notifications (i.e., messages) in the “application” from the sender. After receiving the notifications, the processor 110 parses the notification content using the methods to extract the notification context according to the related art. Based on the extracted notification context, the processor 110 uses the emoticons to display in the particular size based on the notification ratio. As shown in FIG. 14, the graphical representation 102 includes emoticons (i.e., where the images of the senders are replaced with the emoticons) to display the notification context.

FIG. 15 is an example scenario in which the graphical representation 102 including the images of the senders displayed according to the number of messages received from different senders, according to an embodiment of the present disclosure. As shown in FIG. 15, in the notification bar, the processor 110 displays the images of the senders according to the number of messages displayed from different senders. The user performs the gesture (i.e., scrolling) to display more notifications received from other senders in the notification bar.

Referring to FIG. 15, after detecting the gesture, the processor 110 changes the images of the senders view according to the updated notifications received from different senders. Here, the notification ratio is calculated for only notifications which are visible to the user.

FIG. 16 is an example scenario in which the graphical representation 102 including the thumbnail image of the applications of the notifications and the image of the sender is displayed on the screen of the electronic device, according to an embodiment of the present disclosure. For example, the processor 110 tracks whether the user has received the notifications from the same sender in different applications.

Referring to FIG. 16, the processor 110 calculates the notification ratio between different applications for the same sender and generates the pie chart (i.e., graphical representation 102) based on the calculated notification ratio. Further, the processor 110 extracts the images from the memory 140 or downloaded from the Internet representing those application in which the notifications received. As shown in FIG. 16, the user has received three notifications i.e., two from Messenger App and one from the application. The icon of the Messenger App and the application are displayed in 2:1 ratio as shown in FIG. 16.

FIGS. 17A to 17C are example scenarios in which the user can directly access the notification in the particular application by performing the gesture, according to an embodiment of the present disclosure. Consider a scenario where the user has received five notifications from the same senders in two applications two notifications from the application and the three notifications from the Messenger App).

Referring to FIGS. 17A to 17C, in the notification panel, the processor 110 calculates the notification ratio between the SNS-1 App and the Messenger App for the same sender. Further, the processor 110 extracts the images from the memory 140 or downloaded from the Internet representing those applications in which the notifications are received. The icon of the Message App and the application are displayed in 3:2 ratios as shown in the FIGS. 17A to 17C. Further, the user performs the gesture on the Message App to check the notification received by the user in the Message App.

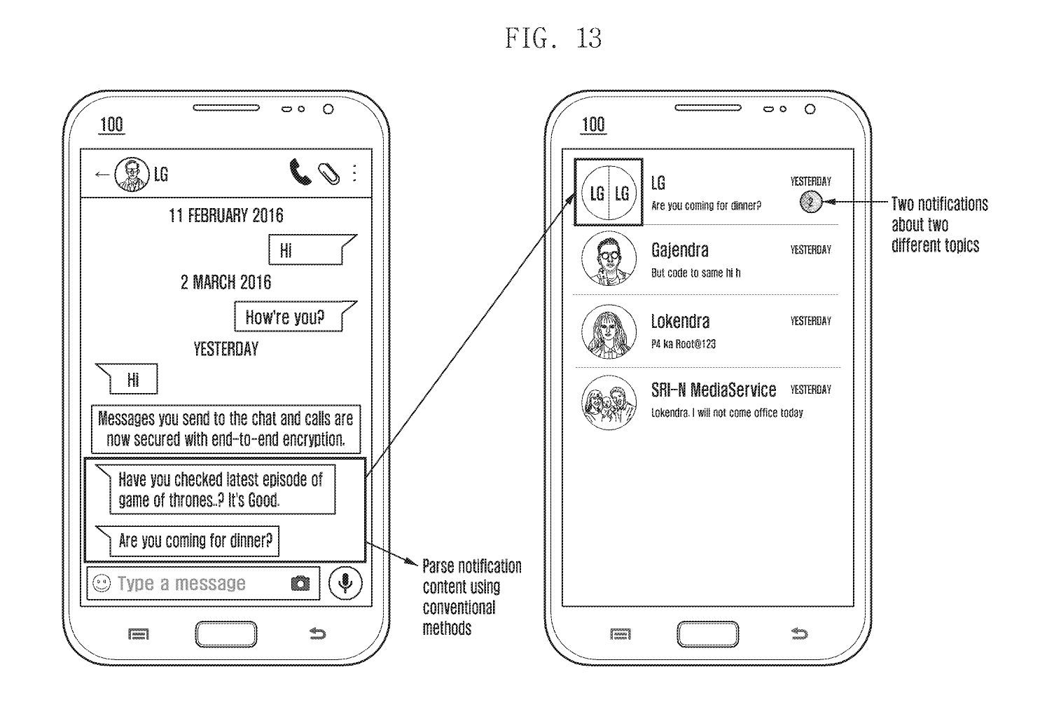

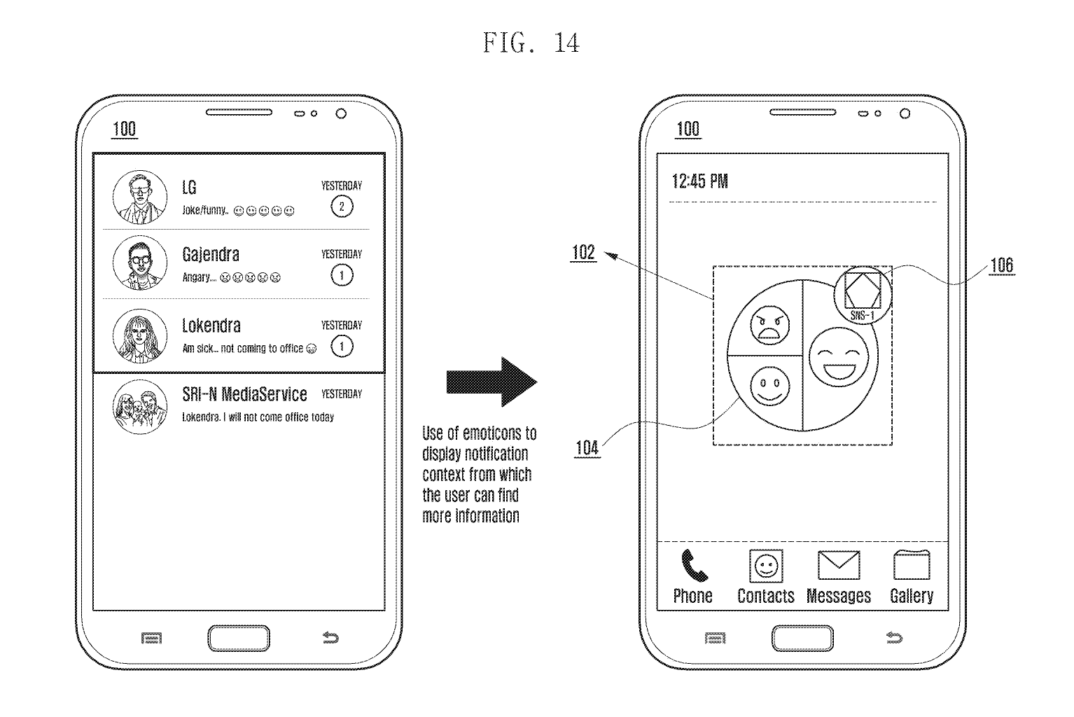

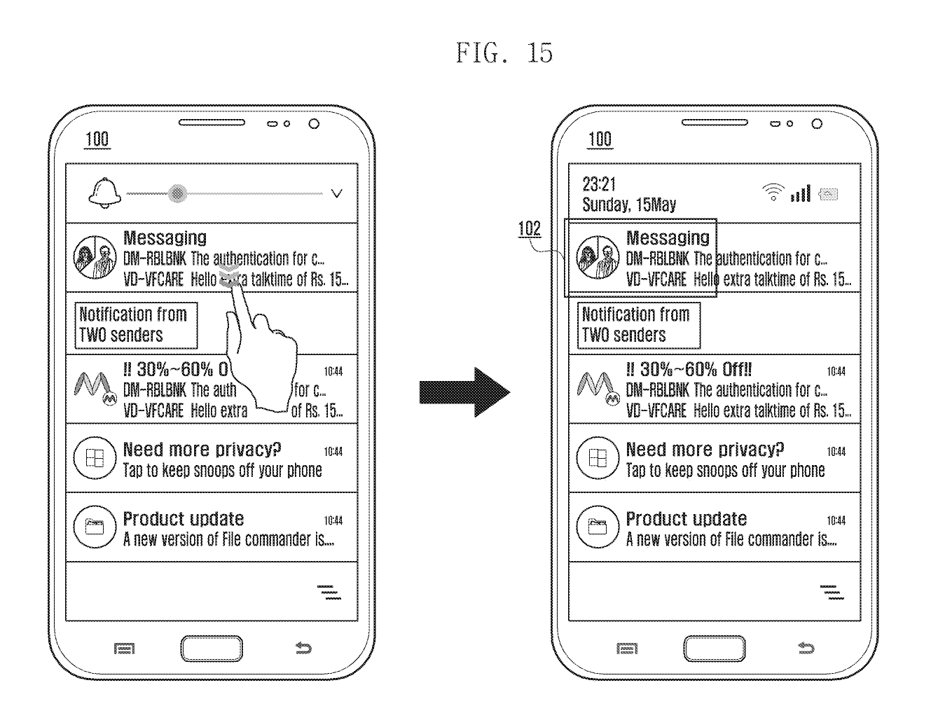

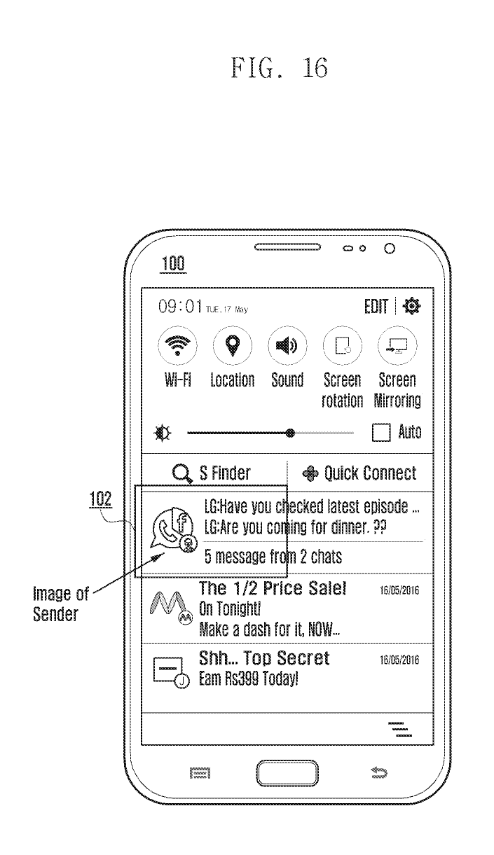

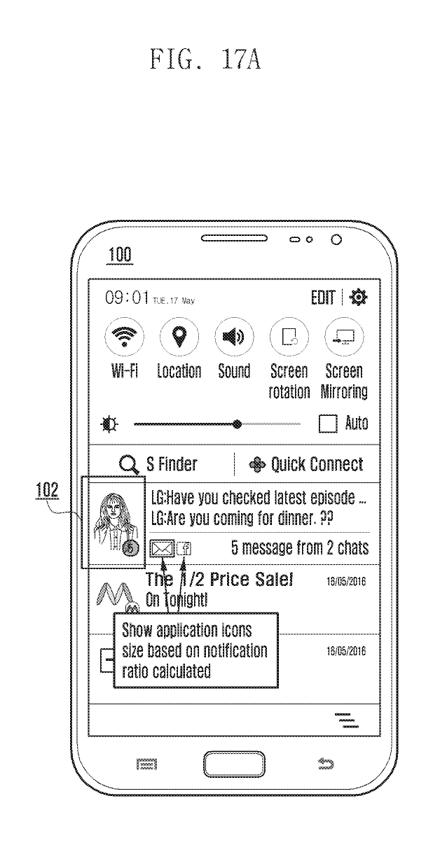

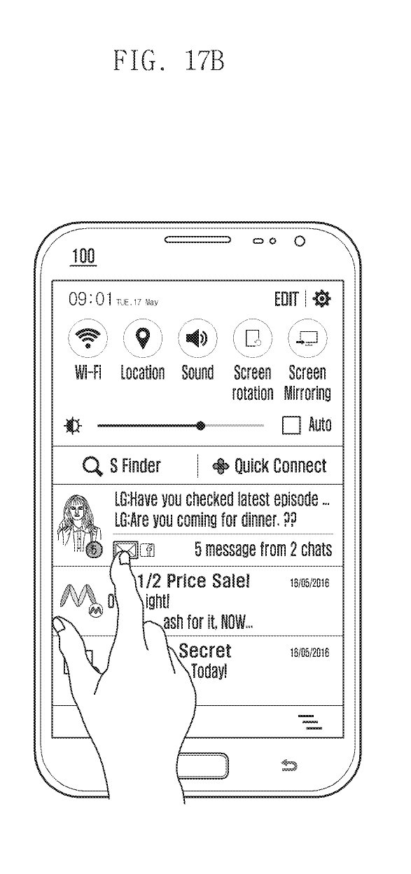

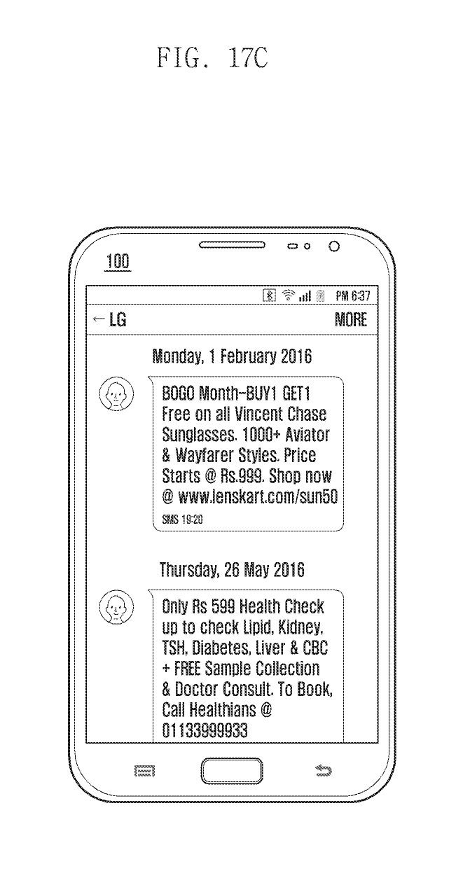

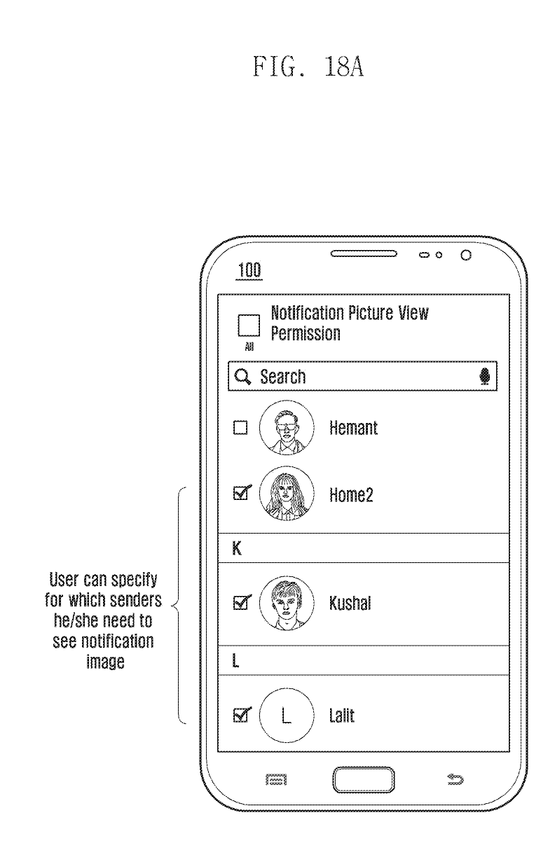

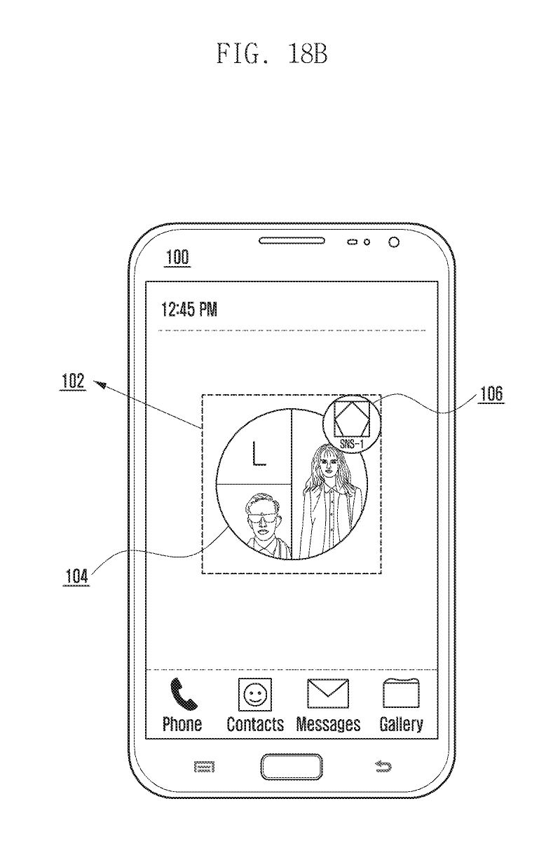

FIGS. 18A and 18B are example scenarios in which the user selects the senders for which the user needs to view the image of the senders when the notification is received, according to an embodiment of the present disclosure. Initially, the user specifies for which of the senders the images of the senders need to be displayed on the screen of the electronic device 100 after receiving the notifications. The processor 110 maintains the permission list indicating the number of senders selected by the user to display the image of the senders when the notification is received. Further, as shown in the FIGS. 18A and 18B, the processor 110 displays the images of the senders for which the user has provided permission. If the image of the sender is unavailable then, a default image is displayed to the user.

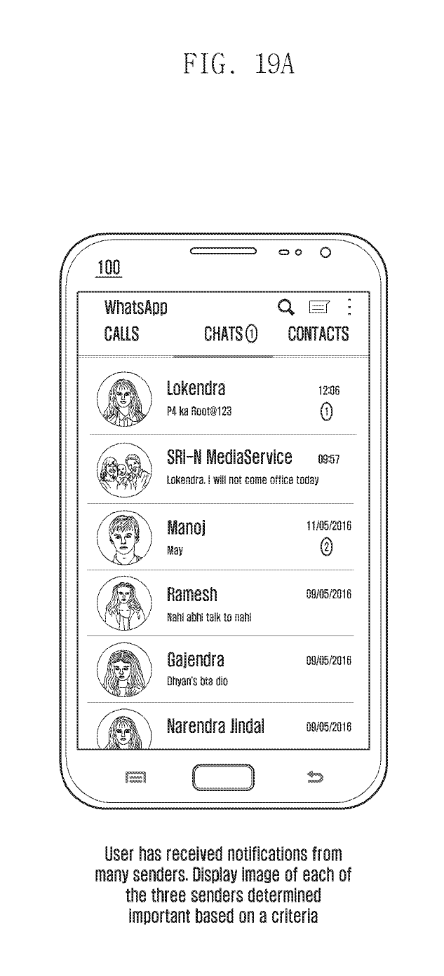

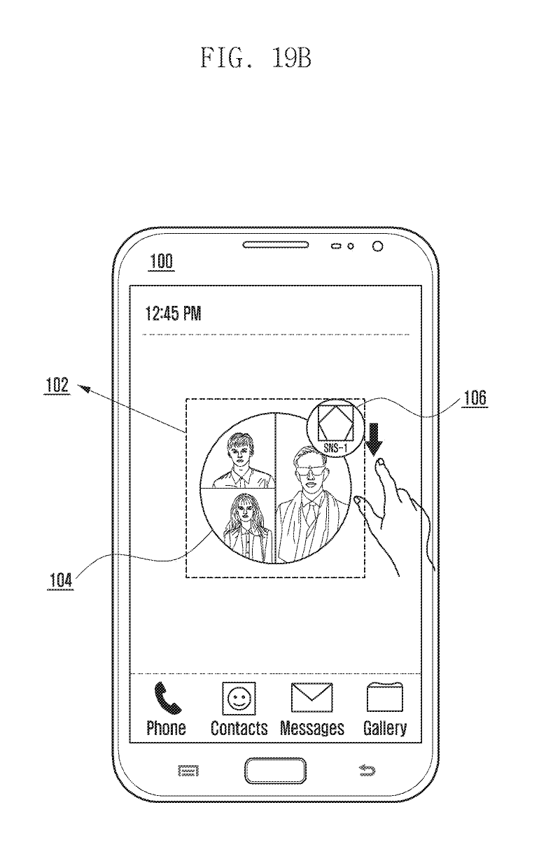

FIGS. 19A to 19C are example scenarios in which the user can access the notifications received from different senders by performing the gesture on the graphical representation 102, according to an embodiment of the present disclosure. Consider a scenario where the user has received the notifications from many different senders. For example, the images of the senders with a highest priority are displayed to the user within the graphical representation 102. Further, the images of the senders are changed as per the priority based on the user input (i.e., user scrolling) or automatically (i.e., as per time interval).

Referring to FIGS. 19A to 19C, the images of the senders are changed based on a time limit (may be decided automatically by the processor 110 or manually by the user) or based on a scroll length. The image of the senders displayed based on the priority depends on the notification ratio, a degree of closeness between the sender and the user, previous communication history, the notification content, a sender state, a user state, or the like. As shown in the FIGS. 19A to 19C, the images of three senders with the highest priority are display. The user can scroll after observing the images of the senders. The processor 110 clears the notifications from those senders and displays the images of the senders of those which are not displayed initially.

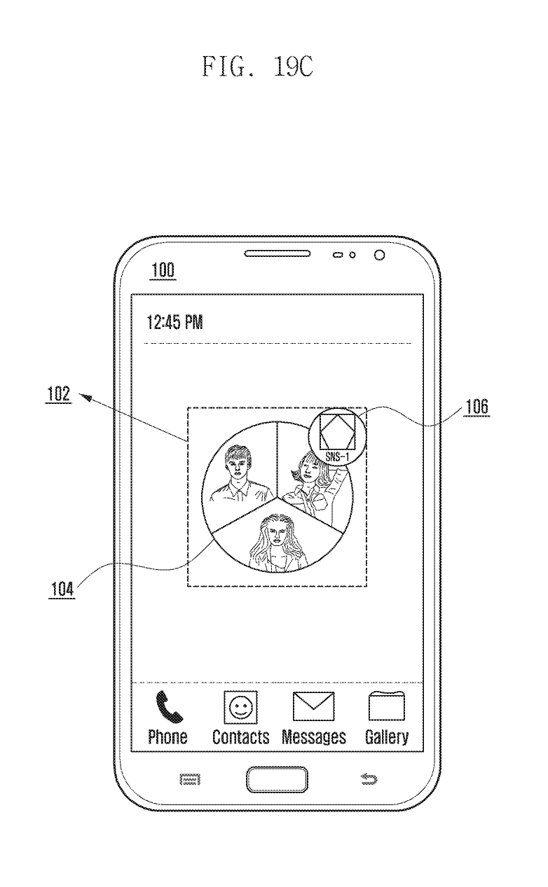

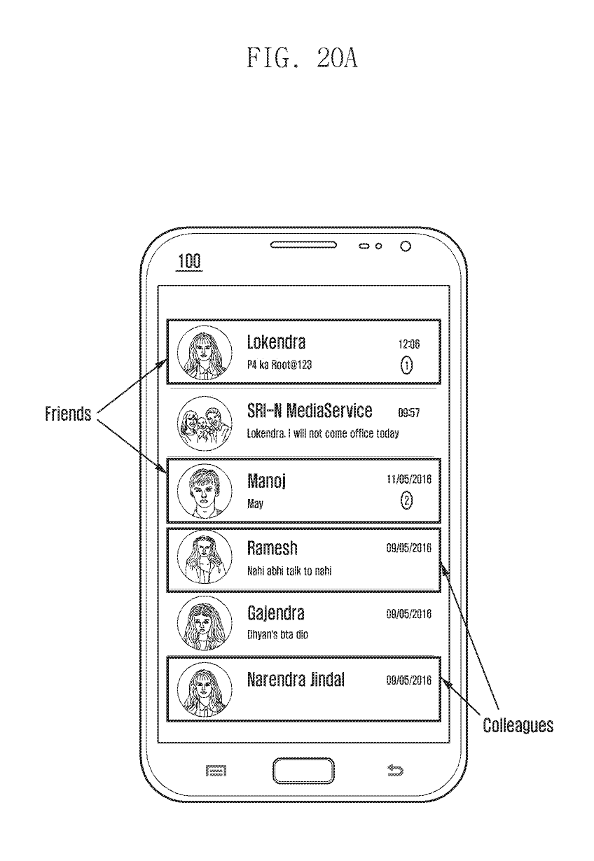

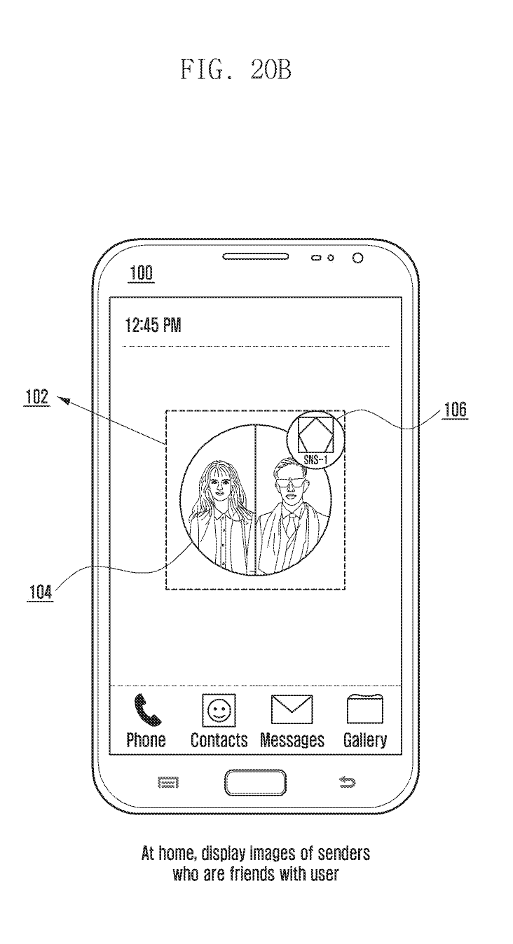

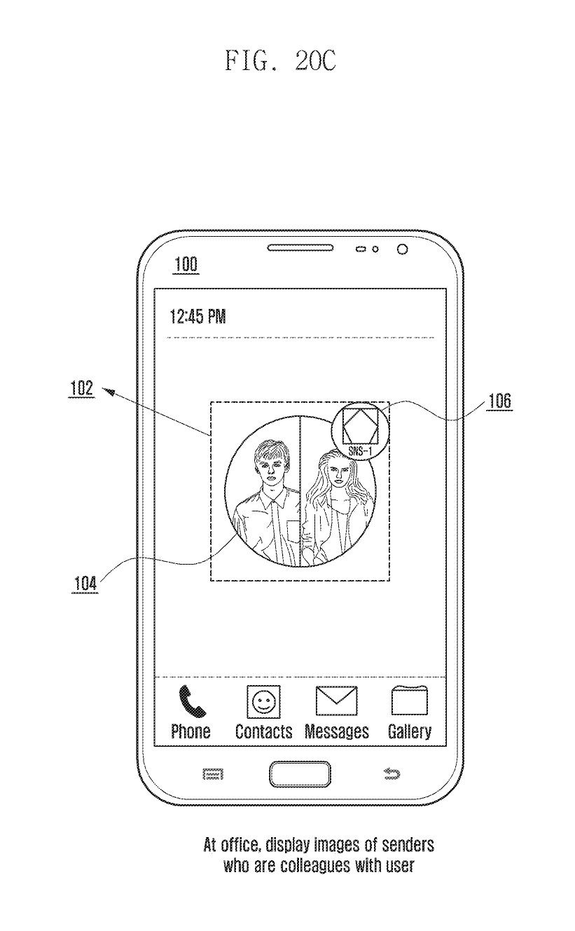

FIGS. 20A to 20C are example scenarios in which the images of the senders are displayed based on the location of the user, according to an embodiment of the present disclosure. Consider a scenario in which the user has received different notifications from friends and colleagues. As the space of the graphical representation 102 is limited and can display limited images only, the images of the senders are displayed based on the location of the user i.e., home or office. At home, the images of the senders are displayed who are friends with the user as shown in the FIGS. 20A to 20C. Further, at office, the images of the senders are displayed who are colleagues with the user as shown in the FIGS. 20A to 20C.

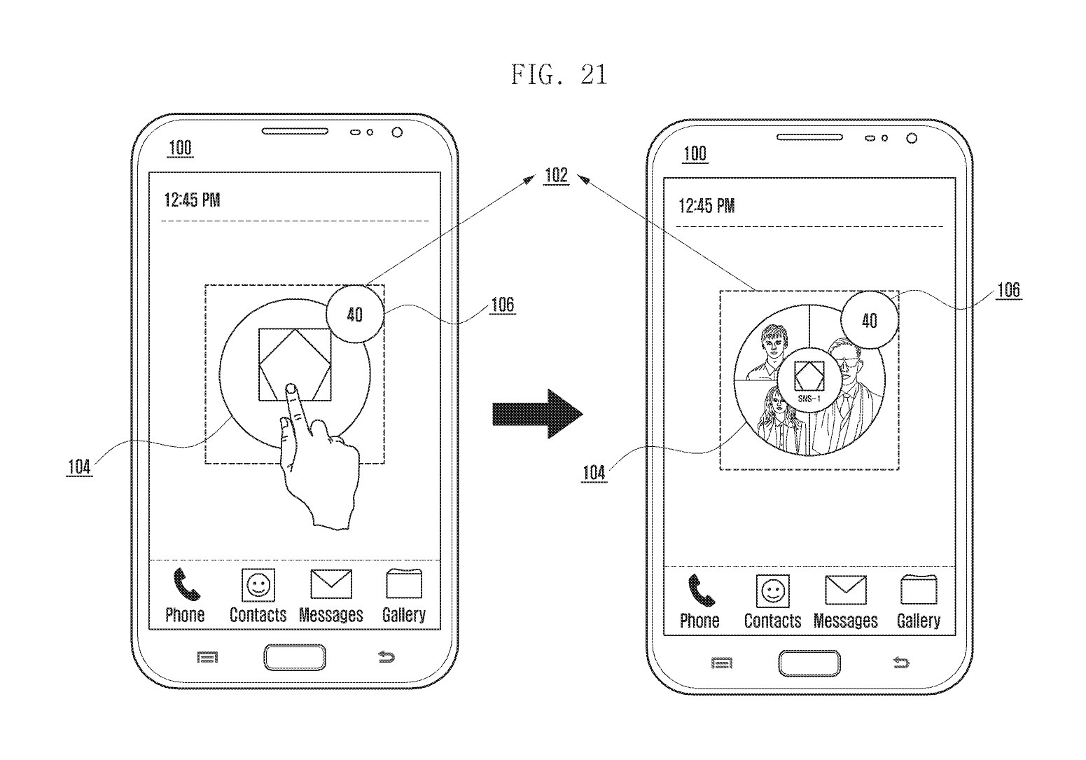

FIG. 21 is an example scenario in which the images of the sender are displayed when the user performs the gesture on the thumbnail image of the application, according to an embodiment of the present disclosure. For example, the processor 110 causes to display the graphical representation 102 including the thumbnail image of the application of the notifications and the count of number of notifications received from different senders.

Referring to FIG. 21, the processor 110 detects the user input performed on the graphical representation 102. In an embodiment, the user can hold the graphical representation 102 and drag the thumbnail image of the application. After detecting the user input, the processor 110 causes to display the images of the senders of the notifications as shown in FIG. 21.

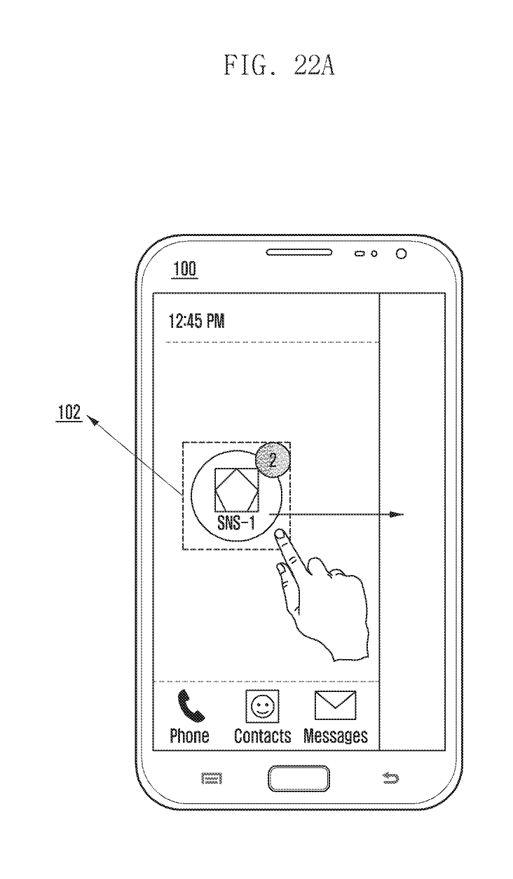

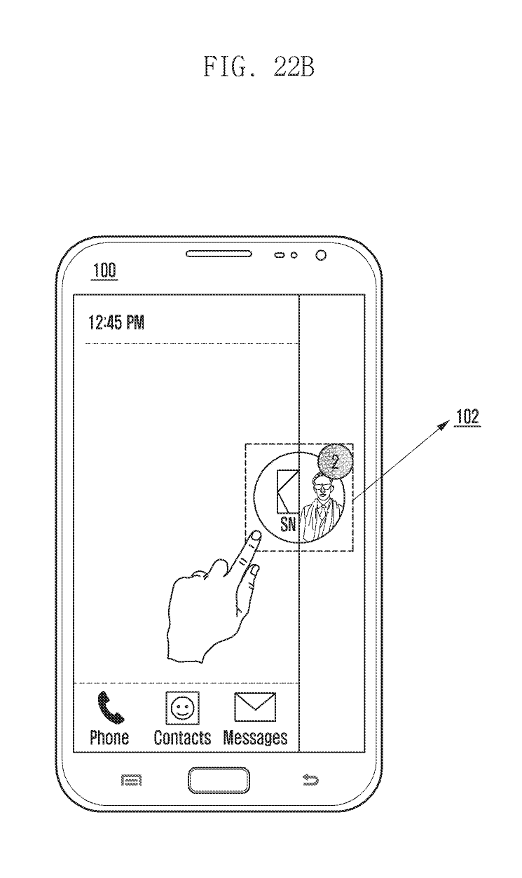

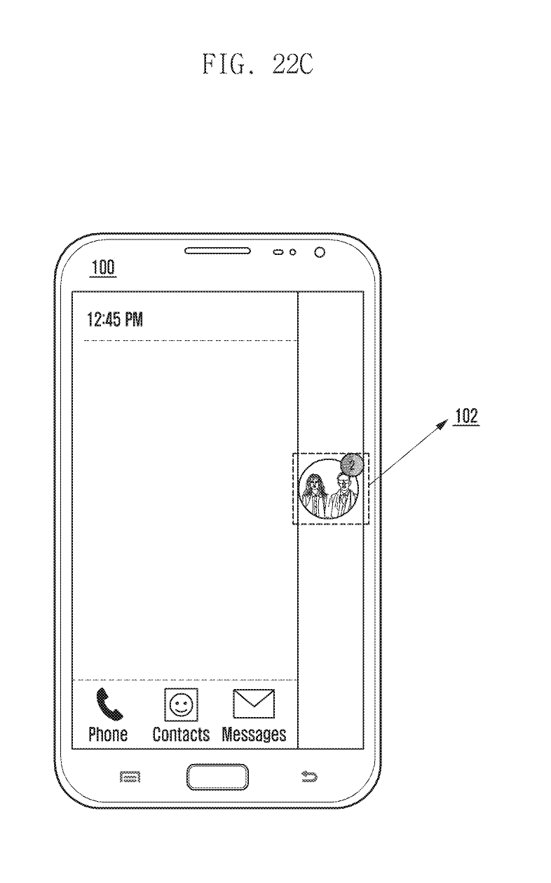

FIG. 22 is an example scenario in which the information of the sender is displayed when the graphical representation 102 is moved to the edge area (i.e., specific area) of the electronic device 100, according to an embodiment of the present disclosure. For example, the processor 110 detects the gesture (i.e., drag) performed to move the portion of the portion of the graphical representation 102 to the edge area of the electronic device 100. After moving the graphical representation 102 to the edge area, the processor 110 performs the action to display the images of the senders as shown in FIG. 22. The images of the senders are displayed based on the portion of the graphical representation 102 moved to the edge area of the electronic device 100.

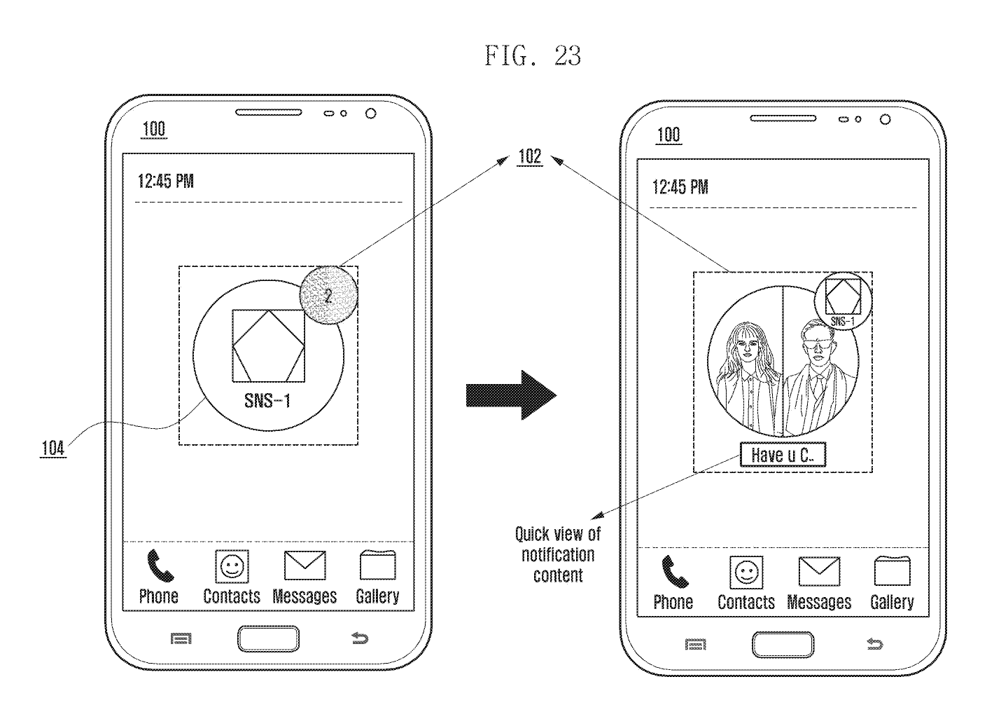

FIG. 2B is an example scenario in which the content of the notification is displayed on the screen of the electronic device 100, according to an embodiment of the present disclosure. For example, the processor 110 causes to display the content of the notification (i.e., quick view notification content) in place of the name of the application which provides more information, about the notification, to the user as shown in FIG. 23. Further, the processor 110 displays the content of the notification based on focus on the particular sender to quickly view the content of the notification.

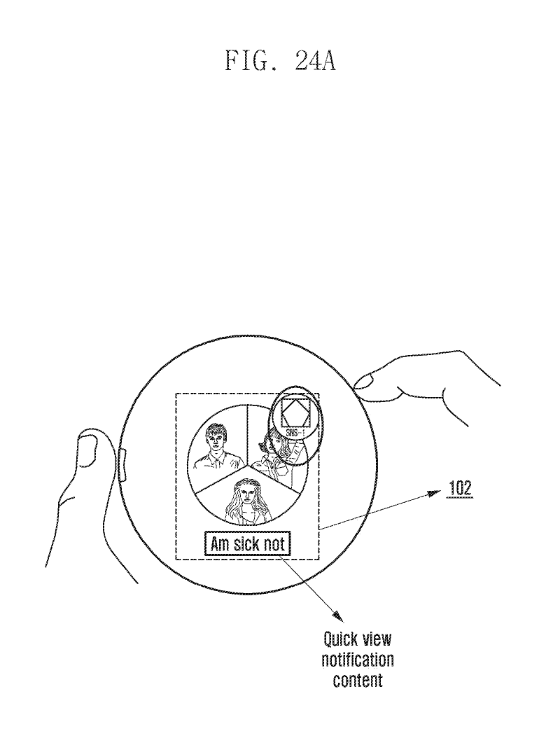

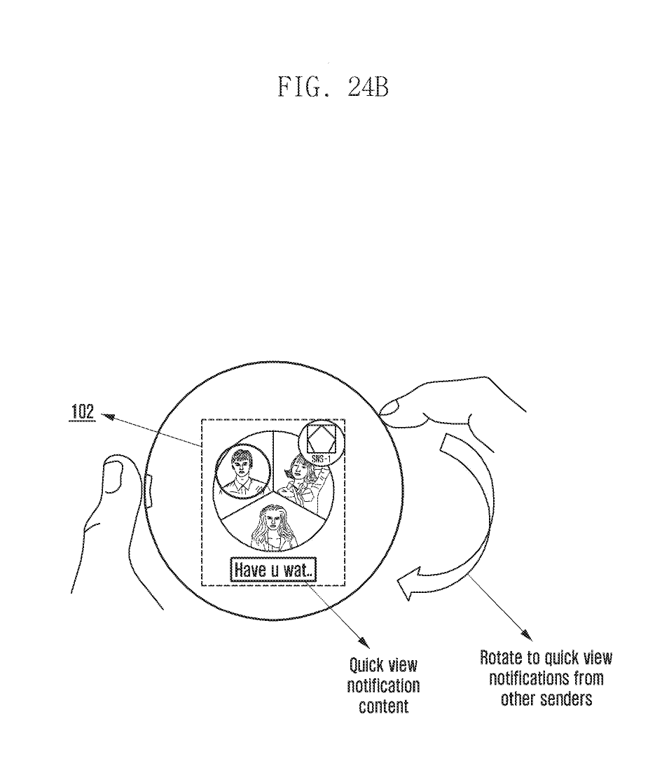

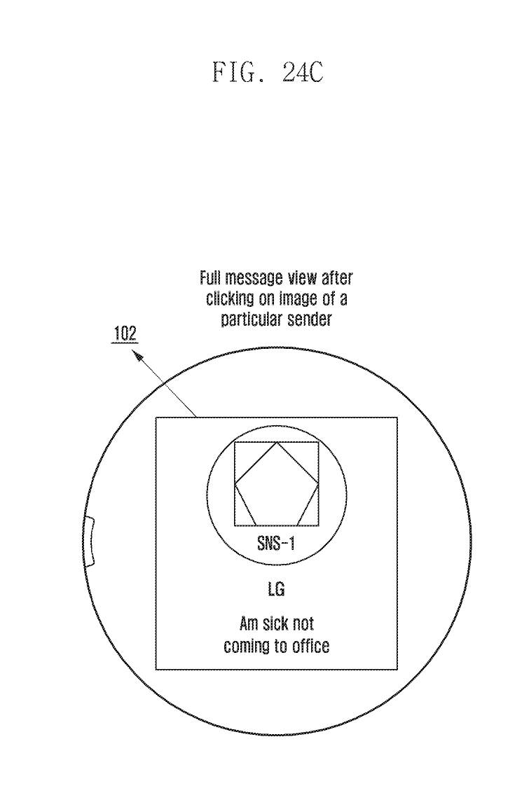

FIG. 24A is an example scenario in which the graphical representation 102 including the images of the senders of the notification and thumbnail image and name of the application is displayed on a screen of the smart watch, according to an embodiment of the present disclosure. For example, the processor 110 causes to display the content of the quick view notification content which provides more information, about the notification to the user as shown in FIG. 24A. Further, the processor 110 displays the content of the notification based on focus on the particular sender to quickly view the content of the notification.

FIG. 24B is an example scenario in which a bezel of the smart watch is rotated to view the notifications received from other senders, according to an embodiment of the present disclosure. As shown in the 24B, the user rotates the bezel of the smart watch to view the content of the notification received from other senders.

FIG. 24C is an example scenario in which the gesture is performed on the image of the sender to display entire content of the notification on the screen of the electronic device 100, according to an embodiment of the present disclosure. As shown in FIG. 24C, the user selects the image of the particular sender to check full notification.

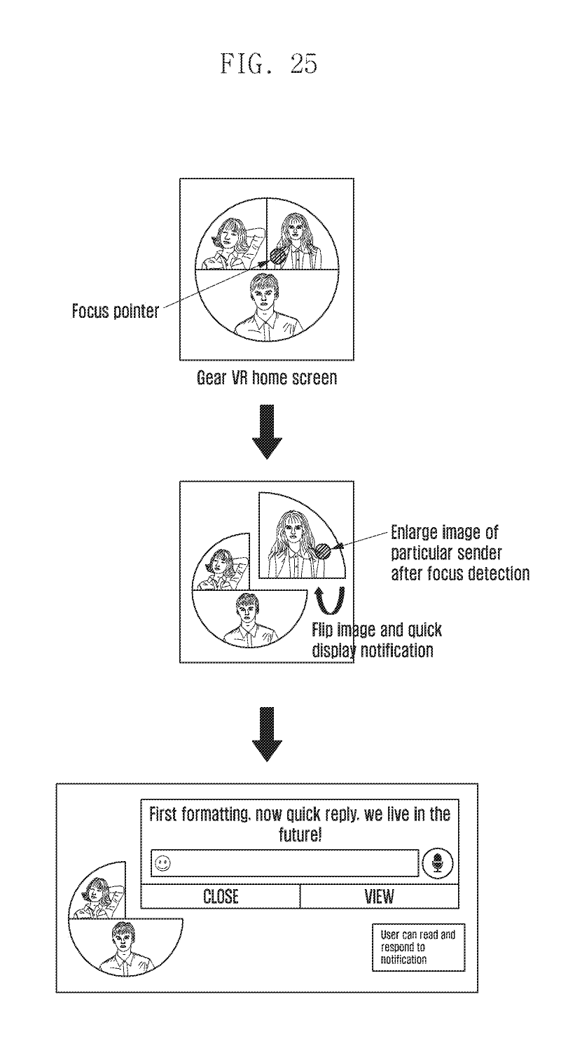

FIG. 25 is an example scenario in which the image of the sender is flipped where the user can respond to the notification, according to an embodiment of the present disclosure. Initially, the graphical representation 102 including the images of the senders is displayed on the screen of a gear device. The processor 110 detects a focus pointer on the image of the sender. After detecting the focus pointer, the processor 110 flips the image of the sender to display the content of the notification within the graphical representation 102 on the screen of the gear device. After displaying the notification, the user can read and respond to the notification as shown in FIG. 25.

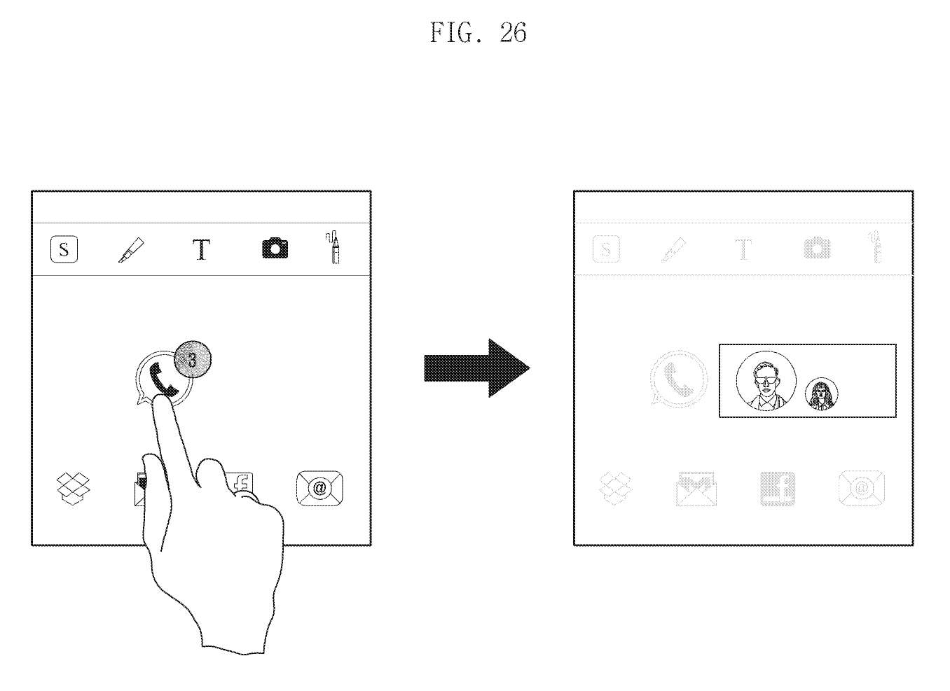

FIG. 26 is an example scenario in which the image of two or more senders is displayed in an adjacent pop-up window, according to an embodiment of the present disclosure. Consider a scenario where the user receives three notifications from two senders, where one of the senders has sent two notifications. The graphical representation 102 including the thumbnail image of the notification and the count of the number of notifications is displayed on the screen of the electronic device 100. After detecting the gesture performed by the user as shown in FIG. 26, the image of the two senders is displayed in the adjacent pop-up window. Here, the size of the image is displayed as per the notification ratio calculated by the processor 110,

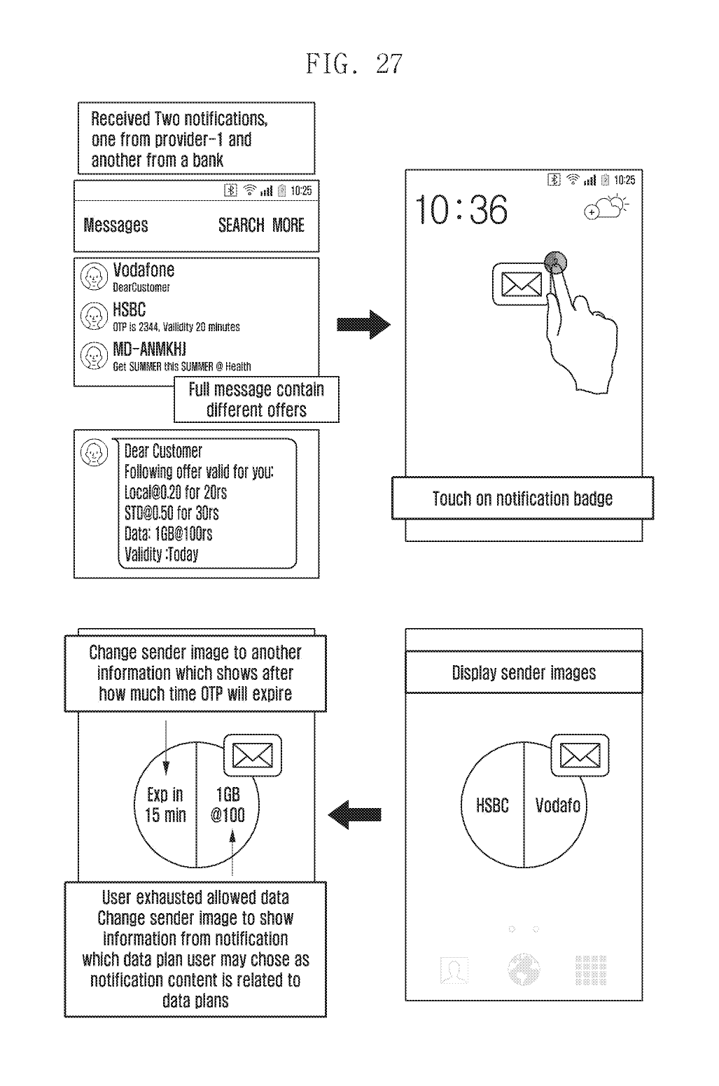

FIG. 27 is an example scenario in which the images of the senders are updated based on the user activities, according to an embodiment of the present disclosure. Consider a scenario where the user received two notifications i.e., one notification from the provider-1 indicating different offers to the user and another message from a bank indicating one time password (OTP). After receiving the notifications, the processor 110 causes to display the graphical representation 102 on the screen of the electronic device 100. The user performs the gesture (i.e., touch input) on the graphical representation 102 to view the images of the senders. The images of the senders are displayed on the screen of the electronic device 100. Further, the processor 110 detects the user activities and changes the image of the sender to display information which shows within how much time the “OTP” expires. Further, another image of the sender is changed to display data plan for the user to select as the notification content is related to data plans.

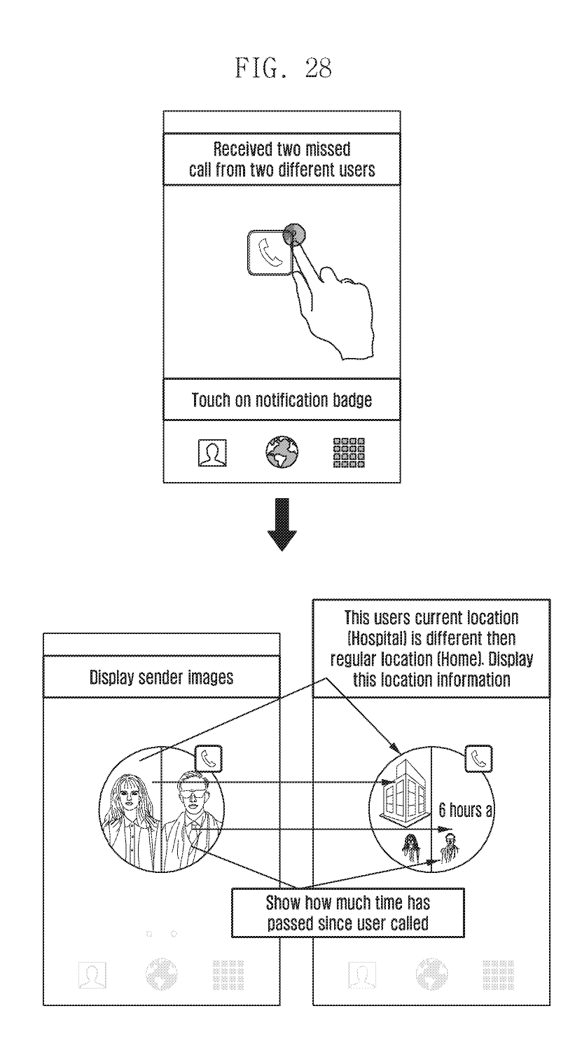

FIG. 28 is an example scenario in which the images of the senders are updated based on current location of the user, according to an embodiment of the present disclosure. Consider a scenario in which the user has received two missed calls from two different senders. The graphical representation 102 including the missed call notifications are displayed on the screen of the electronic device 100. The user performs the gesture on the graphical representation 102 (i.e., notification badge) as shown in FIG. 28. The processor 110 determines the location of one of the sender to be “Hospital” and displays the current location information along with the image of the sender to the user. Further, the processor 110 displays how much time has passed since the sender called along with the image of another sender as shown in FIG. 28.

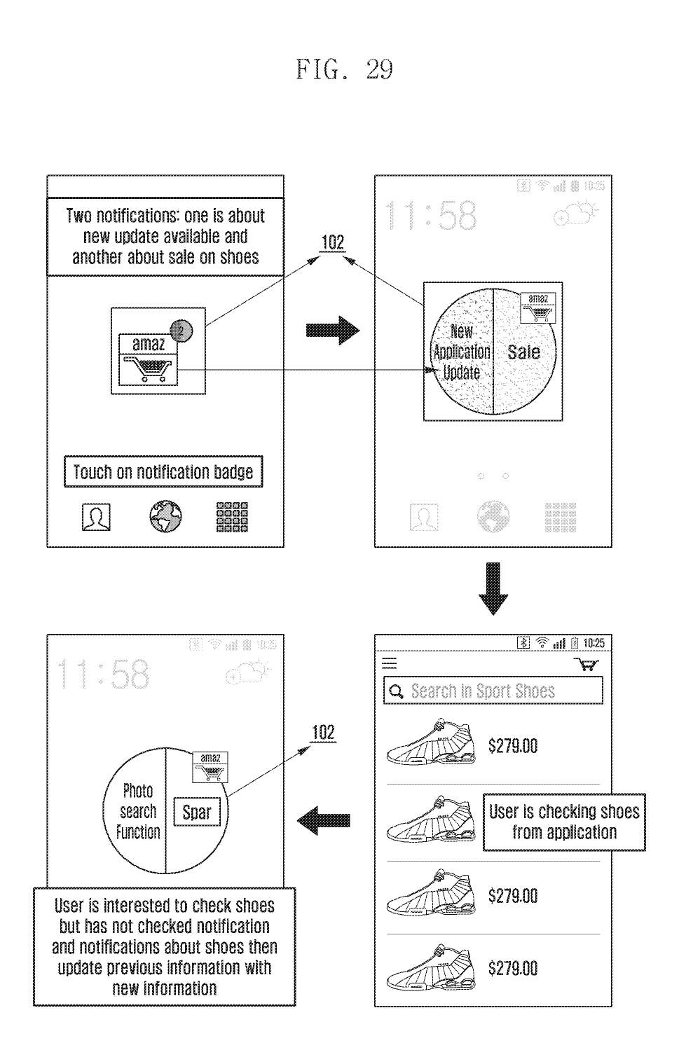

FIG. 29 is another example scenario in which the image of the application is updated based on the activities of the user, according to an embodiment of the present disclosure. Consider a scenario where the user of the electronic device 100 receives two notifications i.e., one is about a new update available in the play store for the user to download and another about sale on shoes as shown in FIG. 29. Further, the user is interested to check “Spar” shoes by accessing the application but has not checked the notification and notification about shoes. The information is updated with the new information based on the activity of the user.

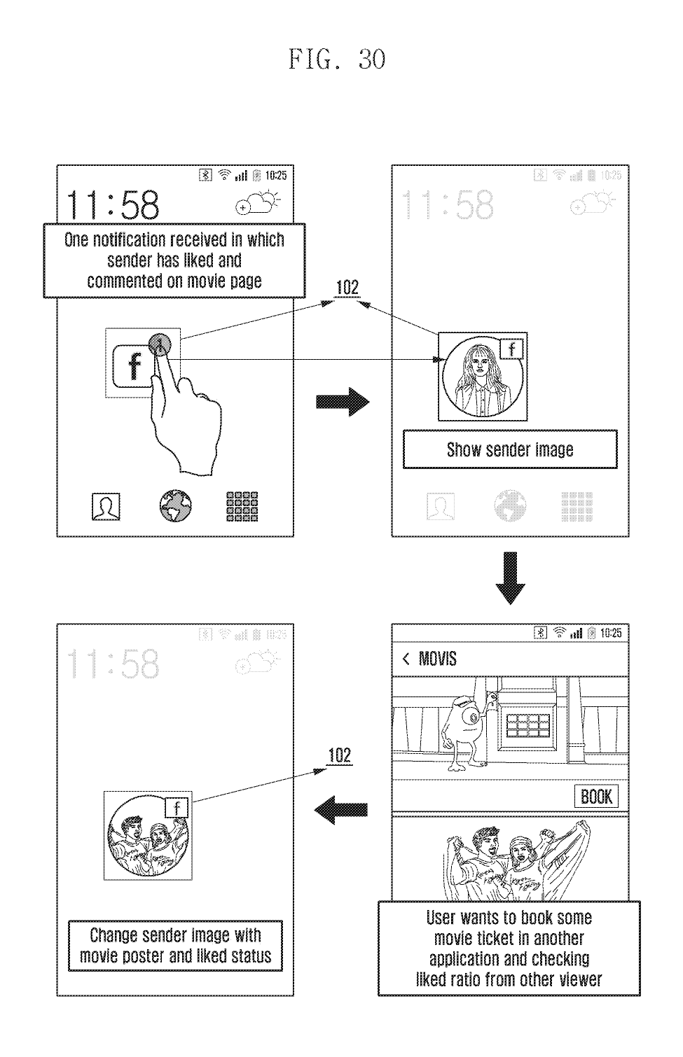

FIG. 30 is an example scenario in which the image of the sender within the graphical representation 102 is changes with a movie poster and liked status, according to an embodiment of the present disclosure. Consider a scenario where the user of the electronic device receives the notification indicating that the user has liked and commented on the movie page. The user performs the gesture on the graphical representation 102 to display the image of the sender. Further, the user needs to book a movie ticket by accessing another application as shown in FIG. 30 and view the rating (i.e., likes from other users). The image of the sender is changed to display the movie poster and liked status as shown in FIG. 30.

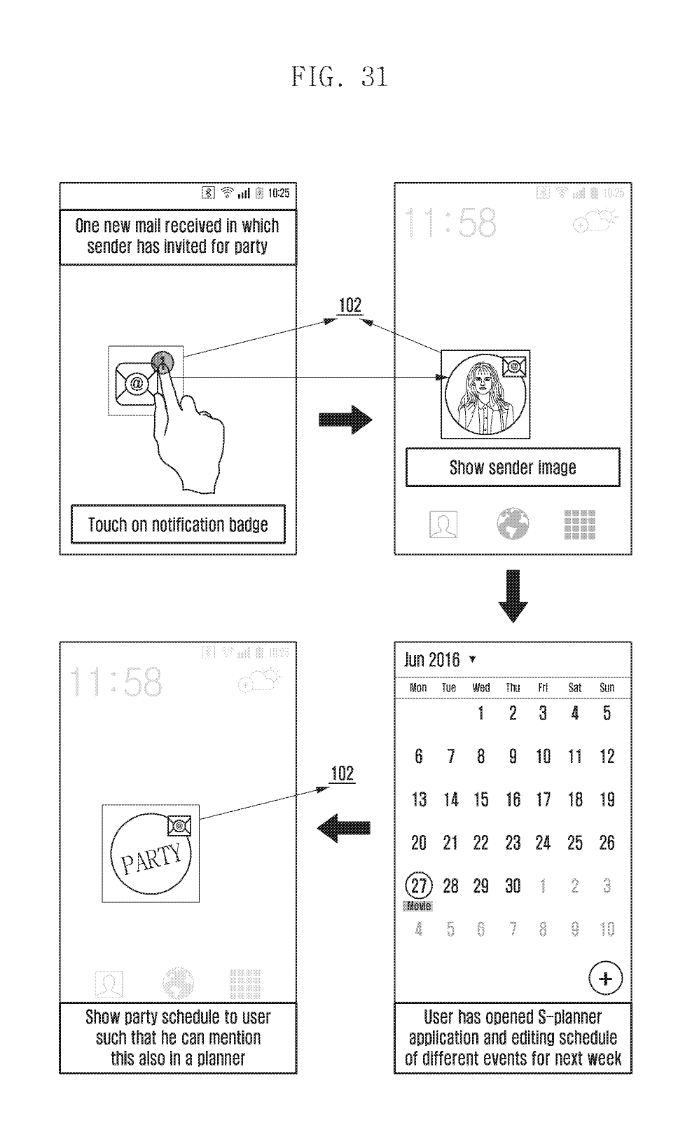

FIG. 31 is an example scenario in which a party schedule is displayed to the user of the electronic device 100, according to an embodiment of the present disclosure. Consider a scenario where the user of the electronic device 100 has received one new mail in which the sender has invited for party. The user performs the gesture on the notification badge to display the image of the sender from which the user has received the notification. Further, the user opens planner application and edits schedule of different events for upcoming week. The party schedule is displayed to the user within the graphical representation 102 such that the user can mention in the planner as shown in FIG. 31.

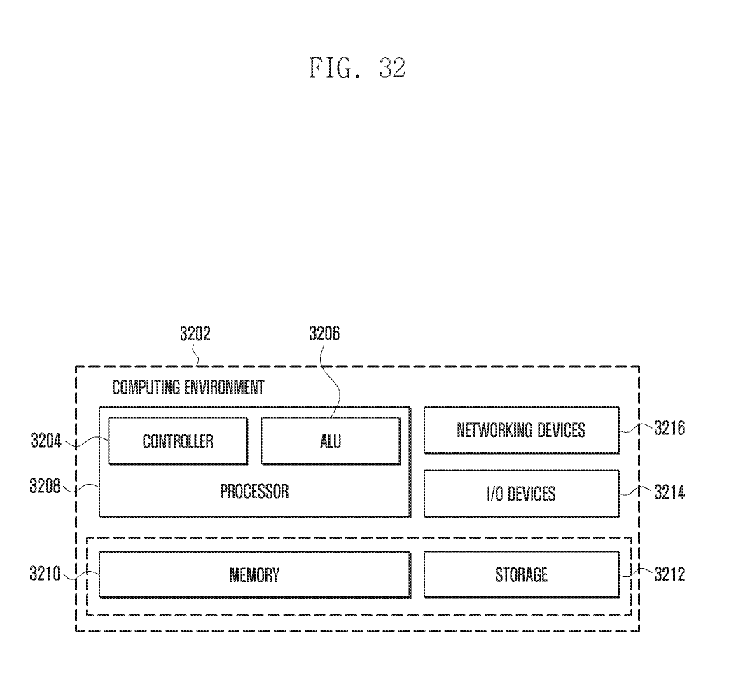

FIG. 32 illustrates a computing environment implementing the method for managing the notifications in the electronic device 100, according to various embodiments of the present disclosure. Referring to FIG. 32, the computing environment 3202 comprises at least one processor 3208 that is equipped with a controller 3204 and an arithmetic logic unit (ALU) 3206, a memory 3210, a storage 3212, plurality of networking devices 3216 and a plurality input output (I/O) devices 3214. The processor 3208 is responsible for processing the instructions of the technique. The processor 3208 receives commands from the controller in order to perform its processing. Further, any logical and arithmetic operations involved in the execution of the instructions are computed with the help of the ALU 3206.

The overall computing environment 3202 can be composed of multiple homogeneous and/or heterogeneous cores, multiple central processing units (CPUs) of different kinds, special media and other accelerators. The processor 3208 is responsible for processing the instructions of the technique. Further, the plurality of processor 3208 may be located on a single chip or over multiple chips.

The technique comprising of instructions and codes required for the implementation are stored in either the memory 3210 or the storage 3212 or both. At the time of execution, the instructions may be fetched from the corresponding memory 3210 or storage 3212, and executed by the processor 3208,

In case of any hardware implementations various networking devices 3216 or external I/O devices 3214 may be connected to the computing environment to support the implementation through the networking devices and the I/O devices.

The embodiments disclosed herein can be implemented through at least one software program running on at least one hardware device and performing network management functions to control the elements. The elements shown in the FIGS. 1A through 32 include blocks which can be at least one of a hardware device, or a combination of hardware device and software module.

While the present disclosure has been shown and described with reference to various embodiments thereof, it will be understood by those skilled in the art that that various changes in form and details may be made therein without departing from the spirit and scope of the present disclosure as defined by the appended claims and their equivalents.

What is claimed is:

1. A method for managing notifications in an electronic device, the method comprising:
receiving, by a processor, at east one notification from a plurality of senders; and
controlling, by the processor, to display a graphical representation comprising an identity of the at least one notification from each of the senders and at least one indicator indicating an identity of at least one application corresponding to the at least one notification,
wherein the identity includes an image related to a corresponding sender.

2. The method of claim 1, wherein the identity of the at least one notification from each of the senders is dynamically updated based on activities of a user of the electronic device.

3. The method of claim 1, wherein the identity for each of the notification to be displayed is automatically defined based on a plurality of parameter comprising at least one of a sender of the notification, content of the notification, one or more user activities, a location of a user of the electronic device, a location of the sender, a category of the notification, a degree of closeness, or a communication history.

4. The method of claim 1,
wherein the identity to be displayed is defined based on a face value, and
wherein the is defined based on at least one of a number of notifications, a sender of the notification, content of the notification, one or more user activities, a location of a user of the electronic device, a location of the sender, a category of the notification, a degree of closeness, or a communication history.

5. The method of claim 1, wherein the identity of the at least one notification comprises at least one of a thumbnail image of at least one sender of the at least one notification, a name of the at least one sender of the at least one notification, a descriptor of content of the at least one notification, or a user defined identifier for the at least one notification.

6. The method of claim 1, wherein the identity of the at least one application comprises at least one of an image icon of the at least one application corresponding to the at least one notification, a name of the at least one application corresponding to the at least one notification, or a user defined identifier for the at least one application corresponding to the at least one notification.

7. The method of claim 1, wherein the identity of the at least one notification from each of the senders is scrolled based on a gesture performed on the graphical representation.

8. The method of claim 1, further comprising:
detecting, by the processor, a gesture performed on a portion of the graphical representation displaying the identity of the at least one notification; and
performing, by the processor, an action to transition the portion of the graphical representation to display content of the at least one notification within the portion of the graphical representation.

9. The method of claim 1, further comprising:
detecting, by the processor, a gesture performed on a portion of the graphical representation displaying the identity of the at least one notification; and
causing, by the processor, to display content of the notification on a screen of the electronic device.

10. The method of claim 1, further comprising:
detecting, by the processor, a gesture performed to move at least one portion of the graphical representation to a specific area of the electronic device; and
performing, by the processor, an action based on the gesture.

11. An electronic device for managing notifications, the electronic device comprising:
a memory; and
a processor, coupled to the memory, and configured to:
receive at least one notification from a plurality of senders; and
control to display a graphical representation comprising an identity of the at least one notification from each of the senders and at least one indicator indicating an identity of at least one application corresponding to the at least one notification,
wherein the identity includes an image related to a corresponding sender.

12. The electronic device of claim 11, wherein the identity of the at least one notification from each of the senders is dynamically updated based on activities of a user of the electronic device.

13. The electronic device of claim 11, wherein the identity for each of the notification to be displayed is automatically defined based on a plurality of parameter comprising at least one of a sender of the notification, content of the notification, one or more user activities, a location of a user of the electronic device, a location of the sender, a category of the notification, a degree of closeness, or a communication history.

14. The electronic device of claim 11,
wherein a face value of the identity to be displayed is defined based on a notification ratio, and
wherein the notification ratio is defined based on at least one of a number of notifications, a sender of the notification, content of the notification, one or more user activities, a location of a user of the electronic device, a location of the sender, a category of the notification, a degree of closeness, or a communication history.

15. The electronic device of claim 11, wherein the identity of the at least one notification comprises at least one of a thumbnail image of at least one sender of the at least one notification, a name of the at least one sender of the at least one notification, a descriptor of content of the at least one notification, or a user defined identifier for the at least one notification.

16. The electronic device of claim 11, wherein the identity of the at least one application comprises at least one of an image icon of the at least one application corresponding to the at least one notification, a name of the at least one application corresponding to the at least one notification, or a user defined identifier for the at least one application corresponding to the at least one notification.

17. The electronic device of claim 11, wherein the identity of the at least one notification from each of the senders is scrolled based on a gesture performed on the graphical representation.

18. The electronic device of claim 11, wherein the processor further configured to:
detect a gesture performed on a portion of the graphical representation displaying the identity of the at least one notification; and
perform an action to transition the portion of the graphical representation to display content of the at least one notification within the portion of the graphical representation.

19. The electronic device of claim 11, wherein the processor further configured to:
detect a gesture performed on a portion of the graphical representation displaying the identity of the at least one notification; and
cause to display content of the notification on a screen of the electronic device.

20. The electronic device of claim 11, wherein the processor further configured to:
detect a gesture performed to move at least one portion of the graphical representation to a specific area of the electronic device; and
perform an action based on the gesture.

21. A computer program product including a computer executable program code recorded on a non-transitory computer readable non-transitory storage medium, which when executed by a processor, causes the processor to:
receive at least one notification from a plurality of senders; and
control to display a graphical representation comprising an identity of the at least one notification from each of the senders and at least one indicator indicating an identity of at least one application corresponding to the at least one notification,
wherein the identity includes an image related to a corresponding sender.
